(19) United States
(12) Patent Application Publication
(10) Pub. No.: US 2019/0118430 A1
(43) Pub. Date: Apr. 25, 2019

(54) System And Method For Minimally Invasive Injection Foam

(71) Applicant: CertainTeed Corporation, Malvern, PA (US)

(72) Inventor: Douglas Lamm, Somerville, MA (US)

(21) Appl. No.: 16/221,156

(22) Filed: Dec. 14, 2018

Related U.S. Application Data
(63) Continuation of application No. 15/251,783, filed on Aug. 30, 2016.
(60) Provisional application No. 62/222,281, filed on Sep. 23, 2015.

(51) Int. Cl. B29C 44/18; B29C 44/34; B29C 44/36; E04B 1/76

(52) U.S. Cl. CPC B29C 44/18; B29C 44/3461; B29K 2105/045; E04B 1/7604; B29C 44/36

(57) ABSTRACT

A method for filling a cavity with an expanding insulating foam component includes the following. First, providing a closed cavity comprising at least one elongated wall surface that extends along a first direction and includes first and second opposite sides, a top side and a bottom side. Next, forming a plurality of openings in the elongated wall surface arranged along the first direction and being alternating close to the first or the second opposite sides. Next, inserting a dispense tube through a first opening of the plurality of openings, and injecting a first portion of the expanding insulating foam into the closed cavity. The first opening is located close to the bottom side and close to the first side of the elongated wall surface. The injected foam expands along the bottom side and the first side and forms a first sloped top surface that has a positive slope angle. Next, inserting the dispense tube through a second opening of the plurality of openings located close and above the first opening and close to the opposite second side, and injecting a second portion of the expanding insulating foam into the closed cavity. The injected foam expands along the first sloped top surface and the second side and forms a second sloped top surface that has a negative slope angle.

### CROSS REFERENCE TO RELATED CO-PENDING APPLICATIONS

This application claims the benefit of U.S. provisional application Ser. No. 62/222,281 filed on Sep. 23, 2015 and entitled MINIMALLY INVASIVE INJECTION FOAM SYSTEM which is commonly assigned and the contents of which are expressly incorporated herein by reference.

### FIELD OF INVENTION

The present invention relates to system and a method for a minimally invasive injection foam, and in particular to injection of foam into cavities for retrofit insulation of buildings, insulation of new buildings, insulation of appliances and other articles of manufacture, fabrication of molded preformed foam products and other products containing a two component chemical mixture.

### BACKGROUND OF THE INVENTION

Heating and cooling of buildings uses approximately 35% of all the energy consumed in the United States of America (USA). Thanks to numerous innovations in construction practices and materials used in new construction, new buildings use less than half the energy per square foot of older buildings. However, the number of new buildings built each year is only about 2% of the number of existing buildings. Since most buildings last for 50 years or more, it will take several generations before low energy new buildings begin to have a significant impact on the overall energy used by buildings in the USA. Thus there is an urgent national need for simple low cost retrofit energy saving technologies that can be applied to existing buildings to achieve energy use similar to new buildings.

The most common approach to reduce thermal energy use in existing buildings is “weatherization”. In a typical weatherization job, a contractor seals air leaks and adds additional blown in fibrous insulation to the attic of a building. Federal and state governments have invested billions of dollars in weatherization programs. However, most studies indicate that weatherization projects result in average energy savings of only 15% and don't come close to achieving the energy use levels of new buildings. A recent study of weatherization programs, conducted by MIT, the University of Chicago, and the University of California, concluded that the average annual return on government funded weatherization programs is −9%.

Another approach for reducing thermal energy use in buildings is a “deep energy retrofit”. As opposed to the 15% energy savings of a weatherization job, a deep energy retrofit of a building can reduce the thermal energy use by 30%-50% or more. Typical deep energy retrofits involve tearing off siding, resetting windows, reconfiguring roof eaves, fitting foam boards to the exteriors of the building, and replacing the siding. Because of the invasiveness of this process, the cost and time involved is very high. Typical time to complete a deep energy retrofit of a house is several months and often requires building occupants to vacate the building. Typical payback time is 25 years or more. Traditional deep energy retrofits are clearly not viable on a large scale.

Typical insulating materials used in building insulations include solid rigid foam insulating boards, fibrous insulation, and spray or injection foams. Rigid foam insulating boards are composed of small, individual cells separated from each other. The cellular material may be glass or foamed plastic, such as polystyrene, polyurethane, polyisocyanurate, polyolefin, and various elastomeric materials. Fibrous insulation is composed of small-diameter fibers, which finely divide the air space. Examples of fibrous insulation include fiberglass and mineral wool type insulations. Foam-in place insulation includes liquid foams that are sprayed, injected, or poured in place. In spray or injection polyurethane foams a two-component mixture composed of isocyanate and polyol resin are mixed near the tip of a gun. The two most common methods of mixing are impingement mixing (also known as a “high pressure” system), in which two streams of material impact each other under high pressure and static mixing (also known as a “low pressure” system), in which the two streams of material are interlaced using a series of mixing elements. After ejection from the gun, the mixed partially expanded material forms an expanding foam that is sprayed onto roof tiles, concrete slabs, into wall cavities, or through holes drilled into a cavity of a finished wall. Once in place, the mixed foam fully expands. There are two types of foam-in-place insulation: closed-cell and open-cell. In closed-cell foam, the high-density cells are closed and filled with a gas that both enhances insulation value and helps the foam expand to fill the spaces around it. Open-cell foam cells are not as dense as the closed-cell foams and are filled with air, which gives the insulation a spongy texture.

Injection of open or closed cell foam into cavities within a building can achieve many of the same benefits of a traditional deep energy retrofit at costs that are at least an order of magnitude lower—and in days rather than months. Closed cell foam in particular offers many advantages over traditional fiberglass or cellulose insulation since it has twice the insulation value per inch and serves as both an air barrier and vapor barrier. Energy models of a house injected with closed cell foam indicate that thermal energy savings of 30%-50% can be achieved. A typical house can be injected in 3 days and the modeled payback time is 5 years or less.

In a typical liquid foam injection process, 4 or more holes are drilled on the interior or exterior of each cavity within the building, and then a 6″ tube is inserted into these holes and a timed shot of foam is injected and falls to the bottom of the cavity. After the foam has fully expanded and is tack free, a second shot can be injected above the first shot. Each layer of foam is called a “lift”. A typical 14.5″ wide×8′ high cavity is filled with 3 to 4 lifts of foam. As the foam cures within the cavity, it heats up in an exothermic reaction. Heated foam can be easily seen from the outside of the cavity with an infrared camera, and voids within the foam can be identified and corrected with additional shots of foam.

Despite its tremendous potential, injection foam is rarely practiced. One of the main issues is concern about the expanding foam “blowing out” walls. Typical closed cell injection foam, known as “pour foam”, expands 30 times its liquid volume. This significant expansion combined with a compressive strength of 25 psi or more can easily cause existing plaster or drywall to bow out or completely detach from the framing.

Some insulation workers have tried to address this issue by using foams that only expand 3 to 5 times their dispensed volume. These foams, known as “froth foams”, contain a mixture of gaseous and liquid blowing agents. While froth foams are generally preferred over pour foams, the packaging, metering and mixing of froth foams is problematic. Due to the gaseous blowing agent, froth foams are packaged in pressure vessels. Foam in disposable pressure vessels are expensive to package and ship—costing about twice as much as two component pour foams—and have inadequate control over dispensed volume and mixing. Re-usable pressure vessels are heavy, can't easily be moved around inside a building, and are exceedingly difficult for manufacturers to track.

An additional method of addressing the blow out issue is to drill multiple pressure relief holes, often of 1″ diameter or more. Any excess foam flows out of these pressure relief holes to avoid pressure buildup on the walls of the cavity. However, large holes require extensive repair and repainting of the interior or exterior of the wall cavity.

A second, much more significant issue is that the vast majority of existing buildings already contain some insulation—typically fibrous insulation such as fiberglass—installed in the wall cavities. The injection method described above can only be used on those few remaining uninsulated buildings with empty cavities. Attempts to use the standard injection process with previously insulated buildings causes the foam to hang up in the fibrous insulation. This in turn causes large gaps, inconsistent thickness and voids.

Besides these two significant problems with injection foam, two component insulating foams, both spray and injection, whether used for new construction or retrofit, suffer from many additional issues including:
Worker Health and Safety Issues. Current Occupational Safety and Health Administration (OSHA) regulations require spray foam workers to wear protective suits and respirators. Nevertheless, during equipment maintenance or during material spills or other incidental exposures, workers can be exposed to isocyanates, one of the primary ingredients of the spray foam formulation. Some workers develop sensitivities to isocyanates. These sensitivities can cause dangerous systemic reactions, including respiratory failure. Furthermore, spray foam hose pressures are often in excess of 2000 pounds per square inch. A rupture in one of these high pressure hoses can lead to dangerous high pressure chemical spray exposure.
High Cost and Complexity. Equipment to process and apply spray foam usually costs well over $70,000. The high costs of this equipment greatly limit the number of smaller businesses, Do-it-yourselfers and contractors that can take advantage of the improved insulation and moisture performance of foams. Furthermore, the complexity of the equipment often leads to costly maintenance and downtime for insulation workers. Foam insulation is also costly—materials typically cost 2 to 10 times more than fibrous insulation on a volumetric basis.
Inconsistent Insulation Composition. Poorly mixed foam often referred to, as “off ratio foam” is common. Poorly mixed foam can be caused by obstructions in mixing chambers, inconsistent pressures between the various components of the spray foam, poor temperature control of one or both materials, inconsistent material batches and other factors. Foam that is not mixed at the proper ratio results in poor insulation performance, including air leaks, shrinkage and cracking, a strong “fishy” odor, deformation of the walls of the structure to which it is bonded, and delamination.
Inconsistent Insulation Thickness. Because the thickness of the spray foam depends heavily on operator skill, obtaining consistent thickness from less experienced operators is difficult. Thickness variations of 1″ or more within a single cavity are not uncommon.
Job Sequencing Delays. Due to the aforementioned health and safety issues, most spray foam material manufacturers recommend that buildings shouldn't be occupied by workers or occupants for a period of 24 hours after foam has been sprayed. The inability of other trades to work on a building at the same time as spray foam insulators often causes unnecessary job site delays.
Time consuming application. Because two component spray foams exotherm significantly after mixing, the maximum thickness that can be applied at one time is typically about 2″. Since it is often desirable to deposit more than 2″ of thickness, workers are typically required to wait until one layer has cured before applying subsequent layers. The need for multiple passes effectively doubles or triples overall insulation time.
Waste Disposal Issues. For large volume applications, spray foam is usually supplied as a two component material in two 55 gallon drums. An “A Side” usually comprises an isocyanate. A “B Side” usually comprises a polyol. The fully reacted components of the spray foam are not considered a hazardous waste. However, residual unreacted material can usually be found in one or more drums at the end of the job. Drums containing residual “A” side are considered a hazardous waste in many locales and must be disposed of in a hazardous waste treatment storage or disposal facility.
Fire Safety. Most polymeric insulating foams require an ignition barrier consisting of either a fire retardant coating or drywall. The need for a fire retardant covering adds significantly to cost in many applications such as attic rafters and basement walls.
Delamination. As foam cures it cools and shrinks. If the adhesion of the foam to the substrate is weak, shrinking foam can cause delamination and air leaks.
Limited Working Season. Spray foam operations in northern climates are often limited to spring, summer and fall months because ambient or substrate temperatures are too low in winter for the proper chemical reactions within the foam to occur.
High Global Warming Potential. The blowing agents used in spray foams have a very high global warming potential of about 1400. Emerging formulations are lower but are expensive.
Job Site Cleanup. Spraying foam inevitably deposits foam in unintended areas due to overspray. 20% of the time on a spray foam job is typically spent masking areas that can't be sprayed or cleaning up overspray
Removal/recycling and reuse. Because spray foam adheres strongly to substrates, it cannot be reused and is exceedingly difficult to remove. In permanent structures, the removal of foam due to quality issues is exceedingly time consuming and expensive. In temporary emergency and military shelters, foam cannot be re-used at all.
Difficult Electrical and Plumbing Access. Spray foam is typically applied after all electrical wires and plumbing have been installed. However, if changes are required to electrical or plumbing systems, the foam must be chipped or sawed away a very time consuming and difficult process

Many other systems that require mixing of two chemical components in the field suffer from some or all of the problems listed above. Examples of other two-component field applied chemical systems include polyurea coatings, used as protective coatings on bridges and other structures, and structural epoxies used to bond concrete. Alternative systems, methods, and materials of injecting insulating foams that overcome the above mentioned issues would be desirable.

### SUMMARY OF THE INVENTION

The present invention provides minimally invasive methods, systems and materials for dispensing insulating foam into a cavity. The systems are used for injecting foam into existing buildings for retrofit insulation, into new buildings for new construction, into appliances or other articles of manufacture, into molds to create preformed foam products and other products containing a two component chemical mixture. The systems includes tubing to distribute the foam, a mixing system, a metering system, a dispense gun, foam materials, packaging for the materials and means of applying pressure to the materials in order to dispense the materials through the tubes into the cavity.

In general, in one aspect, the invention features a method for filling a cavity with an expanding insulating foam component including the following. First, providing a closed cavity comprising at least one elongated wall surface. The elongated wall surface extends along a first direction and includes first and second opposite sides, a top side, and a bottom side. Next, forming a plurality of openings in the elongated wall surface arranged along the first direction and being alternating close to the first or the second opposite sides. Next, inserting a dispense tube through a first opening of the plurality of openings, and injecting a first portion of the expanding insulating foam into the closed cavity. The first opening is located close to the bottom side and close to the first side of the elongated wall surface. The injected foam expands along the bottom side and the first side and forms a first sloped top surface. The first sloped top surface has a positive slope angle. Next, inserting the dispense tube through a second opening of the plurality of openings located close and above the first opening and close to the opposite second side, and injecting a second portion of the expanding insulating foam into the closed cavity. The injected foam expands along the first sloped top surface and the second side and forms a second sloped top surface, and the second sloped surface has a negative slope angle.

Implementations of this aspect of the invention may include one or more of the following features. The method further includes inserting the dispense tube through additional consecutive openings of the plurality of openings located above the second opening and being alternating close to the first or second sides and injecting additional portions of the expanding insulating foam into the closed cavity until the cavity is filled. The dispense tube extends along a first elongated axis and the expanding insulating foam is injected in-line with the first elongated axis. The expanding insulating foam may be one of froth foam, pour foam, partially pre-expanded pour foam, and fully expanded pour foam.

In general, in another aspect, the invention features a method for filling a cavity with an expanding insulating foam component including the following. First, providing a closed cavity comprising at least one elongated wall surface. The elongated wall surface extends along a first direction and includes first and second opposite sides, a top side, and a bottom side. Next, forming a first opening in the elongated wall surface arranged close to the top side along a midline of the elongated wall surface. Next, inserting a dispense tube through the first opening and injecting a first portion of the expanding insulating foam into the closed cavity. The dispense tube comprises an elongated tube extending along the first direction and the expanding insulating foam is injected perpendicular to the first direction.

Implementations of this aspect of the invention may include one or more of the following features. The dispense tube includes at least two side openings located near a distal end of the elongated tube and arranged opposite to each other along an axis perpendicular to the first direction and the expanding insulating foam is injected into the cavity through the at least two side openings. The method further includes injecting additional portions of the expanding insulating foam into the closed cavity until the cavity is filled. Each of the additional portions of the expanding insulating foam comprises a reduced volume compared to an immediate previous portion of the expanding insulating foam. A finishing portion of the expanding insulating foam comprises a resilient foam. The dispense tube is withdrawn at a controlled rate during the injection of the expanding insulating foam. The method further includes forming a second opening in the elongated wall surface arranged close to the bottom side and the dispense tube extends between the first and second openings and comprises a plurality of pairs of openings arranged along the elongated tube length between the first and second opening. Each pair of openings comprises two side openings arranged opposite to each other along an axis perpendicular to the first direction, and the expanding insulating foam is injected through the pairs of openings perpendicular to the first direction into portions of the closed cavity along the first direction. The method further includes forming a second opening in the elongated wall surface arranged close to the bottom side and the dispense tube extends between the first and second openings and comprises a first pair of openings located near the first opening and a second pair of openings arranged near the second opening and a tube seal located between the first and second pair of openings. Each pair of openings comprises two side openings arranged opposite to each other along an axis perpendicular to the first direction, and the expanding insulating foam is injected through the first and second pairs of openings perpendicular to the first direction into top and bottom portions of the cavity, respectively. The first opening is formed under a lip of a siding positioned onto said elongated wall surface. The first opening is formed under a baseboard. The first opening comprises a diameter of less than 0.5 inch. The closed cavity comprises fibrous insulation. The dispense tube further includes an elongated semi-rigid guide rod inserted through a lumen of the dispense tube. The method further includes providing a semi-rigid guide tube surrounding the dispense tube. An inside surface of the semi-rigid guide tube is coated with a lubricant. The method further includes prior to inserting a dispense tube, inserting a distal end of an elongated semi-rigid guide rod through the opening into the closed cavity, attaching a proximal end of the guide rod to a distal end of the dispense tube, threading the distal end of the guide rod out of the closed cavity through a second opening, and pulling the guide rod out of the closed cavity, leaving behind the distal end of the dispense tube anchored in the center of the closed cavity. The expanding insulating foam comprises first and second foam components and each foam component is injected through a separate supply tube into a mixing tube located inside the closed cavity. The expanding insulating foam comprises first and second foam components and each foam component is injected through a separate supply tube into the closed cavity and the second foam component is supplied via a dispense sled riding on top of a sloped surface formed in the interior of the closed cavity. The method further includes providing a resilient bladder located in the closed cavity, and the resilient bladder comprises an insulating gas. The closed cavity further comprises a second elongated wall opposite to the at least one elongated wall and the method further includes forming a second opening in the second elongated wall and wherein excess expanded foam is configured to drain out of the closed cavity through the second opening. A second cavity is formed outside the closed cavity and the excess expanded foam drains into the second cavity. The expanding insulating foam comprises a pour foam that is pre-expanded to about 30% to 50% of an expected final expansion volume prior to being injected into the closed cavity.

In general, in another aspect, the invention features a method for filling a cavity with an expanding insulating foam component including the following. First, providing a closed cavity comprising at least one elongated wall surface. The elongated wall surface extends along a first direction and comprises first and second opposite sides, a top side, and a bottom side. Next, forming an opening in the elongated wall surface arranged along a midline of the elongated wall surface. Next, pre-expanding a pour foam in a mixing bag to about 30% to 50% of an expected final expansion volume, and then inserting the mixing bag with the pre-expanded pour foam into the closed cavity through the opening. Finally, fully-expanding the pour foam in mixing bag to fill the closed cavity.

In general, in another aspect, the invention features a method for filling a cavity with an expanding insulating foam component including the following. First, providing a closed cavity comprising at least one elongated wall surface. The elongated wall surface extends along a first direction and comprises first and second opposite sides, a top side, and a bottom side. Next, forming an opening in the elongated wall surface arranged close to the bottom side along a midline of the elongated wall surface. Next, inserting a first dispense tube through the opening, so that the first dispense tube is oriented toward the top side, and injecting a first portion of the expanding insulating foam into the closed cavity through the first dispense tube. The injected foam expands along the top side and the second side and forms a first sloped top surface, wherein the first sloped top surface comprises a positive slope angle. Next, injecting a second portion of the expanding insulating foam into the closed cavity through the first dispense tube. The injected foam expands along the first sloped top surface and the first side and forms a second sloped top surface. The second sloped surface comprises a negative slope angle. The method further includes inserting a second dispense tube through the first opening, so that the second dispense tube is oriented toward the bottom side and injecting a third portion of the expanding insulating foam into the closed cavity. The injected foam expands along the bottom side and along the first and second sides. The second dispense tube comprises an elongated tube extending along the first direction and the expanding insulating foam is injected through the elongated tube perpendicular to the first direction.

Among the advantages of the methods of this invention may be one or more of the following. Compared to direct methods of injecting foam, one or more aspects of the Minimally Invasive Injection method reduces the buildup of pressure on cavity walls, eliminates voids in cavities that contain fibrous insulation materials, provides consistent foam thickness, simplifies training, enables injection from either the inside or outside of a structure, minimizes the number of injection holes and reduces or eliminates subsequent repair processes. In addition to the advantages of these methods, the system eliminates the need to change nozzles frequently, improves the mix ratio of the various components of the foam, reduces costs of tubing, nozzles and other disposables, maximizes the distance between the cavity hole and the dispense location, enables workers to stay out of dangerous enclosed spaces and reduces complexity and variables involved in traditional spray foam equipment. In addition to the advantages of the system and methods, the materials described herein improve foam quality due to off ratio foam, reduce global warming potential, reduce cleanup, pose no respiratory risk for insulation workers and building occupants and eliminate hazardous waste disposal issues. Besides use in field application of insulation and for articles of manufacture, the methods, systems and materials described herein can be used to create insulation products for new construction that have lower cost, are easier to install and require less shelf space than traditional insulation products. Finally, the systems and methods described herein can be used in related applications such as application of polyurea coatings and epoxy structural adhesives.

### BRIEF DESCRIPTION OF THE DRAWINGS

FIG. 1 is an elevation view of a cavity 90 filled with fiberglass 180 injected with foam through holes 110 and through dispense tube 130 to deposit mixed fully expanded foam 100 in an alternating pattern;

FIG. 2 is an elevation view of a cavity 90 filled with fiberglass 180 injected with foam through a single hole 110 via dispense tubing 130 and dispensed in a direction 142 that is perpendicular to the dispense tubing 130 to form a centering pattern of mixed fully expanded foam 100;

FIG. 3 is an elevation view of a cavity injected using either a continuous or intermittent withdrawal of dispense tube 130;

FIG. 4 is an elevation view of a cavity with a dispense tube 130 with tube seal 250 centered within the cavity and dispensing from both the top and bottom holes in a centering pattern;

FIG. 5 is an elevation view of a cavity with a dispense tube 130 with many dispense holes 140 dispensing mixed partially expanded foam 105 simultaneously in a centering pattern;

FIG. 6 is an elevation view of a cavity with an alternating pattern of mixed fully expanded foam 100 deposited from the top down through a hole in the bottom of the cavity via tubing 130;

FIG. 7 is an elevation view of a cavity filled from the top down, as in FIG. 6, and the bottom up, as in FIG. 2, through a single hole 110 near the center of the cavity;

FIG. 8 is a cross sectional view of a cavity with dispense tubing 130 positioned on the exterior of the cavity under the lip of siding 155;

FIG. 9 is a cross sectional view of a cavity with tubing 130 being inserted through a hole less than ½″ diameter on the interior of the cavity;

FIG. 10 is a cross sectional view of a cavity filled with fibrous insulation 180 and with dispense tubing 130 guided to the exterior of the fiberglass 180 by inserting an electrician's fish rod/tape 150 inside the tubing;

FIG. 11 is a cross sectional view of a cavity filled with fiberglass 180 and with dispense tubing 130 guided to the exterior of the fiberglass by inserting the dispense tubing 130 into a larger diameter guide tube 160;

FIG. 12 is an elevation view of a cavity with dispense tubing 130 guided through the center of the cavity between two holes 111 and 112;

FIG. 13 is a cross sectional view of a cavity filled with mixed fully expanded foam 100 through a tunnel in the insulating foam 170 formed by removal of an electrician's fish rod/tape;

FIG. 14 is cross section of a cavity with component A side chemical supply hose 282 and component B side chemical supply hose 292 and a mixing dispense tube 135 all inserted within the cavity to cause a delayed mixing;

FIG. 15 is an elevation view of a cathedral ceiling closed cavity with roof sheathing 440, roof rafters 420, fibrous insulation 180, mixed fully expanded foam 100 and unmixed component B supply hose 282 and dispense sled 560;

FIG. 16 is a cross sectional view of a cavity filled with mixed fully expanded foam 100 and fibrous insulation 180 acting as a resilient surface;

FIG. 17 is a cross sectional view of a cavity filled with mixed fully expanded foam 100 and a resilient bladder 190;

FIG. 18 is an elevation view of a cavity filled with mixed fully expanded foam 100 deposited in decreasing volumes as the insulating foam approaches the filling hole 110;

FIG. 19 is an elevation view of a cavity filled with mixed fully expanded foam 100 and a soft resilient insulating foam 200 deposited as the mixed fully expanded foam 100 approaches the filling hole 110;

FIG. 20 is a cross sectional view of a cavity filled with mixed fully expanded foam 100 and fibrous insulation 180 with a pressure relief hole 115 provided between the brick veneer wall and the cavity wall;

FIG. 21 is a cross sectional view of a cavity being filled with mixed partially expanded foam 105 in a mixing bag 220 with external pressure 230 self-extruding into a cavity;

FIG. 22 is an elevation view of a cavity filled with mixed partially expanded foam 105 inserted through slot 222 in a mixing bag 220;

FIG. 23 is a dispense tube 130 with dispense direction 140 parallel to the length of the tube, distance markings 560 and stop line 570;

FIG. 24 is a dispense tube 130 with dispense directions 140 perpendicular to the length of the tube through holes 540 and with tube seal 250 at one end and variable hole spacing 550;

FIG. 25 is a dispense tube 130 with variable sized dispense holes 540 and with tube seal 250 at one end;

FIG. 26 is a dispense tube 130 with multiple tube seals 250 and dispense directions 140 perpendicular to the length of the tube through dispense holes 540;

FIG. 27 is multiwall dispense tube 520 with a manifold 560 that distributes foam in a direction 140 parallel to the length of the dispense tube 520;

FIG. 28 is multiwall dispense tube 520 with a manifold 560 that distributes mixed partially expanded foam 105 through holes 540 in a direction 140 perpendicular to the dispense tube;

FIG. 29 is a mixing dispense tube 135 manufactured from shrink film 240 and shrunk around a rod 150;

FIG. 30 is a mixing dispense tube 135 manufactured from shrink film 240 with intermittent shrink zones 242 around a rod 150;

FIG. 31 is a mixing dispense tube 135 with a string 245 running down the middle;

FIG. 32 is a mixing dispense tube 135 made from coated or partially coated rough porous material 260;

FIG. 33 is a mixing dispense tube 135 with a pattern of mixing channels 265 embossed or imprinted into the tube;

FIG. 34 is a cross sectional view of unthreaded nozzle 300 showing a divider 307 between A side chemical 281 and B side chemical 291;

FIG. 35 is an unthreaded nozzle 300 with a wide diameter opening 305;

FIG. 36 is a mixing dispense tube 135 with nozzle insert 240 shrunk around a rod 320 with a shape than enables insertion of nozzle 300 into the wide end;

FIG. 37 is a mixing dispense tube 135 with a stub 320 into which nozzle 310 can be screwed or inserted using a quick connect fastener;

FIG. 38 is a mixing dispense tube 135 with an external compression fitting 330 that is screwed, slid or tightened around nozzle;

FIG. 39 is a mixing dispense tube 135 with nozzle insert 240 secured in place by pressing an unthreaded nozzle 300 against a guide tube 160;

FIG. 40 is a mixing bag 220 with an A side chemical 280 in flexible packaging, a B side chemical 290 in flexible packaging, a mixing chamber 226, a closure 490 and two puncturing devices 480;

FIG. 41 is a remote dispense sled with trigger valve 570 component A supply line 282, dispense tubing 130 and dispense holes 110;

FIG. 42 illustrates the in wall metering process with mixed fully expanded foam 100 average rise height 380 and fill rate 390;

FIG. 43 is a shot timing table 370 showing number of shot seconds 375 calculated for a 6 inch rise and 10 inch cavity width at a 0.25 inch/second dispense rate;

FIG. 44 is a digital or analog shot timing display and control valve 440 showing shot time 450 as calculated from shot timing parameters 460;

FIG. 45 is two small re-usable pressure vessels 340 containing packaged chemical A 280 and packaged chemical B 290 and labeling 350 and a specified length 355;

FIG. 46 is a cross section of a metering wheel 360 controlling the flow of mixed partially expanded foam 105;

FIG. 47 is a plan view of a metering wheel 360 in position 461 controlling the flow of packaged chemical A 280 and packaged chemical B 290 before having passed through mixing chamber 270 and in position 460 controlling the flow of partially expanded foam 105 after having passed through mixing chamber 270;

FIG. 48 is a plan view of two metering wheels with a common piston 380 controlling the flow of packaged chemical A 280 and packaged chemical B 290 before passing through mixing chamber 270;

FIG. 49 is an elevation view of pre-cured insulating foam beads 410 in a binder 510;

FIG. 49a is an elevation view of partially cured insulating beads 405 being sprayed from a dispense gun 415 in spray pattern 414 within a container 416 having width 411 and height 412 and settling into fully cured insulating beads 410 in the bottom of the container;

FIG. 50 is a cross sectional view of pre-cured insulating foam beads 410 formed by compressing a heat sealer 500 on mixed partially expanded foam 105 in a dispense tube 130 prior to final cure of the insulating foam;

FIG. 51 is an elevation view of partially expanded insulating beads 405 in dispense tube 130;

FIG. 52 is an elevation view of compressed pre-cured insulating beads 406 deposited on top of fully expanded pre-cured insulating beads 410;

FIG. 53 is a cross sectional view of a cavity partially filled with partially expanded insulating beads 405;

FIG. 54 is a cross sectional view of a cavity filled with fully expanded insulating beads 410;

FIG. 55 is a cross sectional view of a cathedral ceiling closed cavity with roof sheathing 440, roof rafters 420, mixed fully expanded foam 100 and fibrous insulation 180;

FIG. 56 is cross sectional view of a cathedral ceiling closed cavity with roof sheathing 440, roof rafters 420, fibrous insulation 180, guide sheet 522, spacer 524 and mixed partially expanded foam 105 being dispensed through a multiwall dispense tube 520;

FIG. 57 is an elevation view of a cathedral ceiling closed cavity with roof sheathing 440, roof rafters 420, fibrous insulation 180 and mixed partially expanded foam 105 being dispensed through a multiwall dispense tube 520;

FIG. 58 is a cross sectional view of an open cavity with fibrous insulation 180 and mixed fully expanded foam 100 injected behind the fibrous insulation;

FIG. 59 is a cross sectional view of an open cavity, a barrier material 450, a molding surface 190 and insulating foam injected behind the molding surface and barrier material;

FIG. 60 is a cross sectional view of an open cavity, a barrier material 450 bonded to the mixed fully expanded foam 100, and the molding surface 190 removed;

FIG. 61 is a cross sectional view of an open cavity, a foam insulating board 460, and mixed fully expanded foam 100 injected behind the insulating board;

FIG. 62 is a cross section view of an open cavity 90, a fibrous insulation board 180 bonded to a foam insulating board 460 and mixed fully expanded foam 100 injected behind;

FIG. 63 is a cross sectional view of an open cavity, as found in a roof rafter, with injected foam 100 behind fibrous insulation 180;

FIG. 64 is an elevation view of an open cavity, as found in a roof rafter, with roof sheathing 440, roof rafters 420, fibrous insulation 180, mixed fully expanded foam 100 and dispense direction 140;

FIG. 65 is an elevation view of an open cavity, as found in a rim joist between floors of a building, injected through tubing 130 in a direction 142 towards the rim joist through the ceiling panel 435;

FIG. 66 is an elevation view of an open cavity, as found on the floor of an attic, injected through tubing 130 towards the outside of the building and underneath fibrous insulation 180;

FIG. 67 is an elevation view of an open cavity, as found in a kneewall, injected through tubing 130 from the closed side of the cavity in an inward direction 142 towards the closed side of the cavity;

FIG. 68 is a cross sectional view of a molded insulation product with mixed fully expanded foam 100 and fibrous insulation 180 after release from a molding cavity;

FIG. 69 is a cross sectional view of a molded insulation product with mixed fully expanded foam 100 and foam insulating board or expanding insulation board 460 after release from a molding cavity; and

FIG. 70 is a cross sectional view of a molded insulation product with mixed fully expanded foam 100 and an insulating bladder 190 after release from a molding cavity.

### DETAILED DESCRIPTION OF THE INVENTION

### Methods

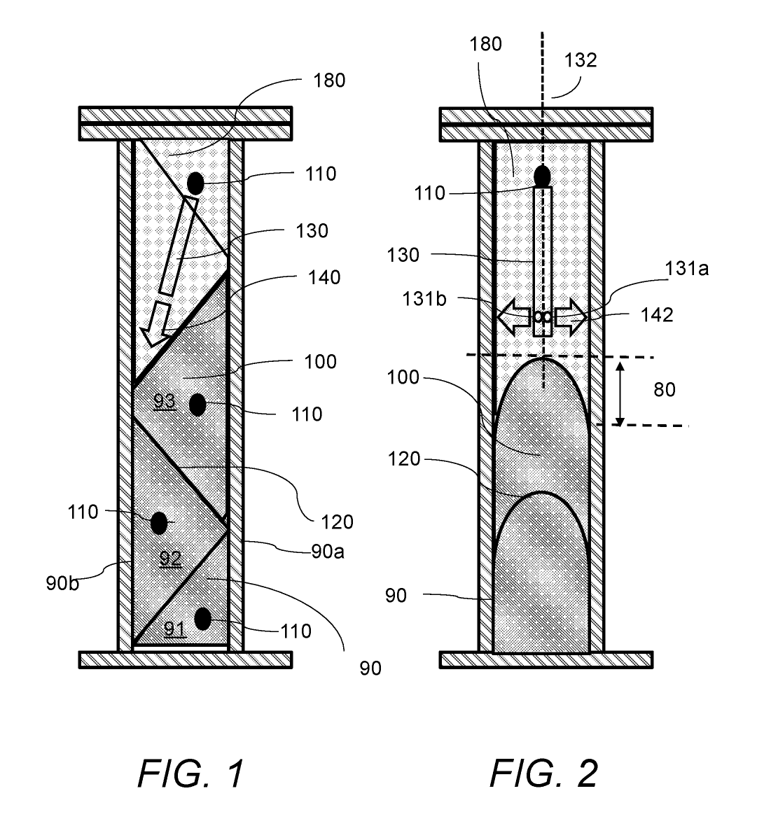

Foam-in-place insulating foams are formed when an A side chemical (typically isocyanate) and a B side chemical (typically polyol) are mixed to form a mixed partially expanded foam. This mixed partially expanded foam is subsequently sprayed or injected in place where it continues to expand to form a mixed fully expanded foam. Referring to FIG. 1 and FIG. 2, mixed partially expanded foam is injected into a wall cavity 90 either directly through injection holes 110, as shown at the bottom of FIG. 1, or remotely by using a dispense tube 130, as shown at the top of FIG. 2. The mixed partially expanded foam is dispensed either directly from the tip of a dispense gun or by using a short and narrow straw of 6″ or less in length and ½″ or less in diameter attached to the end of the foam gun. The mixed partially expanded foam is injected directly into multiple openings 110 located along the entire interior or exterior surfaces of wall cavity 90. The direct injection of the mixed partially expanded foam is simple, allows precise control over dispense location and uses small easily repairable holes. Remote dispense of the mixed partially expanded foam is performed by using dispense tubing 130 inserted through a single opening 110 on the interior or exterior surfaces of wall cavity 90. Tube 130 has at the distal end side openings 131a, 131b, that allow injection of the foam along the arrow direction 142 that is perpendicular to the tube direction 132. Remote dispense tubing 130, enables fewer holes to be drilled and productivity is improved and repair and repainting is greatly minimized.

In order to overcome the tendency of foam to hang up on existing fibrous insulation 180, creating voids and gaps, mixed partially expanded foam is injected into cavity 90 either in an alternating pattern, as shown in FIG. 1, or in a centering pattern, as shown in FIG. 2. When injected in an alternating pattern, foam is injected through openings 110 that are arranged to be alternating close to opposite walls 90a, 90b of the cavity 90, as shown in FIG. 1. Foam injected through each of the openings 110 expands along the side of the cavity 90 that is closest to the opening location and pushes toward the center of the cavity. The combination of these forces creates a triangular deposition shape 91. Subsequent injection on the opposite cavity side creates an opposite triangle 92 that knits together along knitting line 120. The alternating deposition pattern ensures that the critically important sides 90a, 90b of the cavity 90 are fully filled and air sealed. The alternating deposition pattern also greatly simplifies tube 130 positioning because the slope of knitting line 120 directs dispense tubing 130 to a location at the bottom of the filled area, as shown in FIG. 1. The alternating deposition pattern also simplifies the tube fabrication. Since, mixed partially expanded foam is dispensed out the end of dispense tubing 130 in a dispense direction 140 parallel to the length of dispense tubing 130, no additional dispense holes need to be created.

In the centering dispense pattern, the dispense direction 142 is perpendicular to the axis 132 of dispense tubing 130, as shown in FIG. 2. When mixed partially expanded foam rises from a central position within a cavity, it creates a “tombstone” shape 120 as shown in FIG. 2. Perpendicular dispense direction 142 ensures that foam fills the distance 80 between the peak of the tombstone and the shoulders of the tombstone. A significant advantage of the centering pattern is that foam thickness is much more consistent across the width of the cavity than with the alternating pattern.

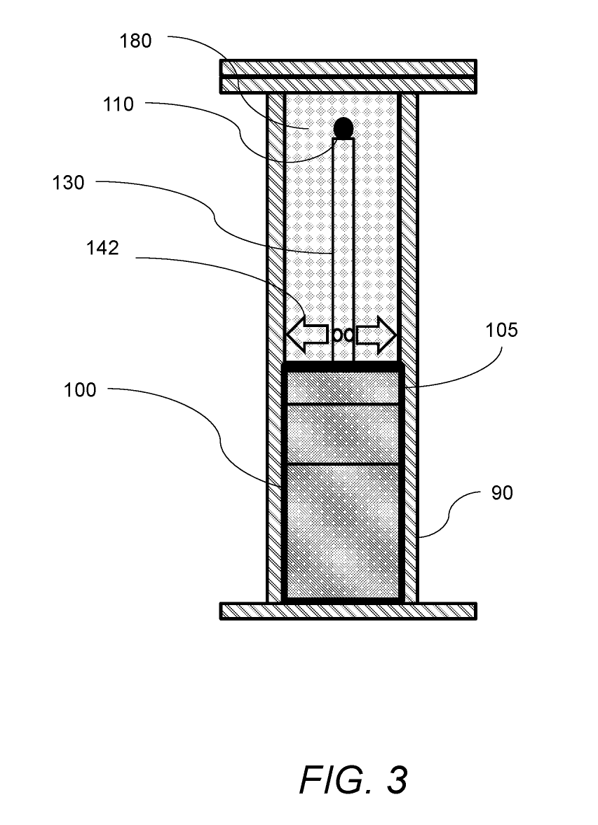

Since insulating foam is expensive compared to fibrous insulation, it can be advantageous to limit the thickness of the insulating foam in hybrid foam/fibrous insulation. This is particularly true of products molded in cavities using the minimally invasive injection process. Referring to FIG. 3, in one embodiment, a continuous or intermittent withdrawal of the dispense tube 130 is used to control the foam thickness across the width of the cavity 90. By withdrawing dispense tube 130 at a controlled rate mixed partially expanded foam 105 is deposited next to mixed fully expanded foam 100. Combining the controlled withdrawal with a centering pattern of dispense, both foam thickness from side to side in the cavity and foam thickness along the entire length of the cavity can be precisely controlled. Moreover, continuous or intermittent dispense reduces the number of dispense tubes and dispense lifts required to fill a cavity.

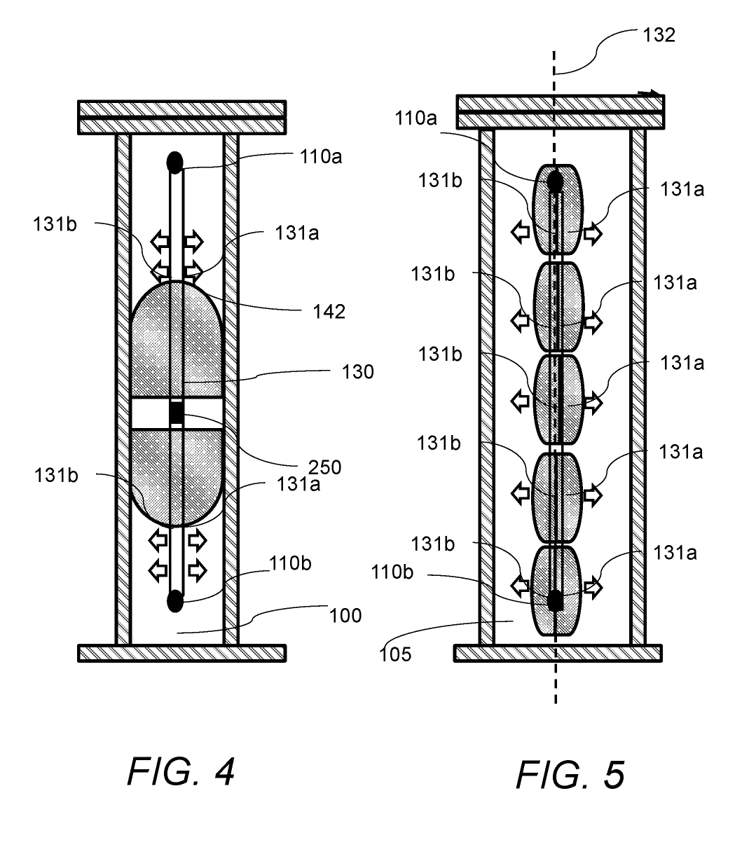

Referring to FIG. 5, tube 130 extends between a top cavity opening 110a and a bottom cavity opening 110b and includes multiple pairs of openings 131a, 131b along axis 132, through which foam is injected in a centering pattern along multiple locations within cavity 90. As illustrated in FIG. 4, material is dispensed just at the top and bottom of a cavity through a single dispense tube 130. In this embodiment, tube 130 extends between a top opening 110a and a bottom opening 110b and has a tube seal 250 in the middle portion. This tube configuration allows simultaneous injection of foam into the top and bottom of cavity 90, which reduces the filling time of the cavity. Because holes in the middle of the cavity are more visible than the top and bottom, this method reduces the appearance of patched holes in the middle of the cavity. It also shortens the distance that mixed foam must travel through the dispense tube.

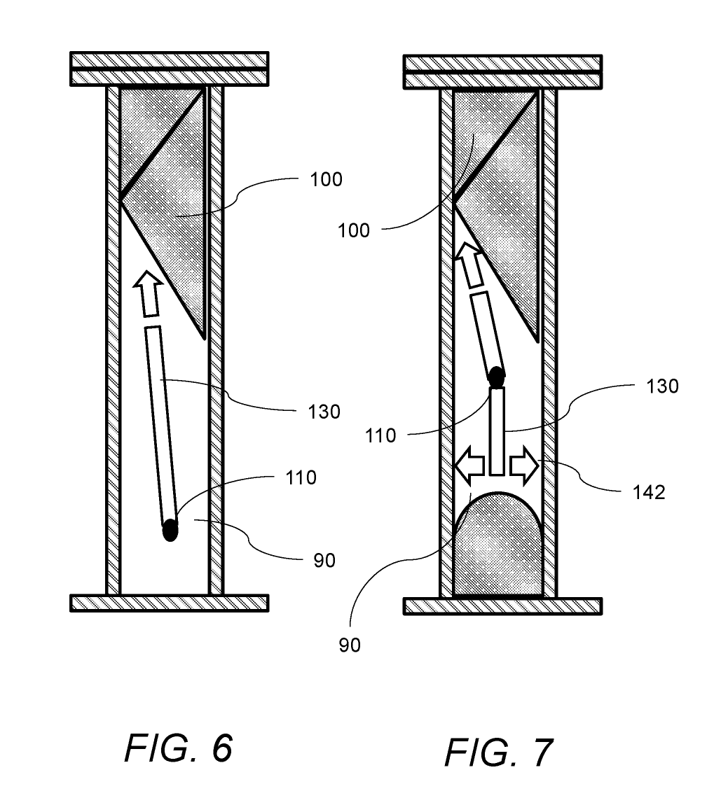

In some embodiments, combinations of injection hole 110 locations and dispense patterns are used. Referring to FIG. 6, an injection hole 110 located at the bottom of the cavity 90 is used to dispense through a dispense tube 130 in an alternating top down, rather than bottom up, pattern. Referring to FIG. 7 a single injection hole 110 in the middle of the cavity 90 is used to dispense both bottom up in a centering pattern and top down in an alternating pattern.

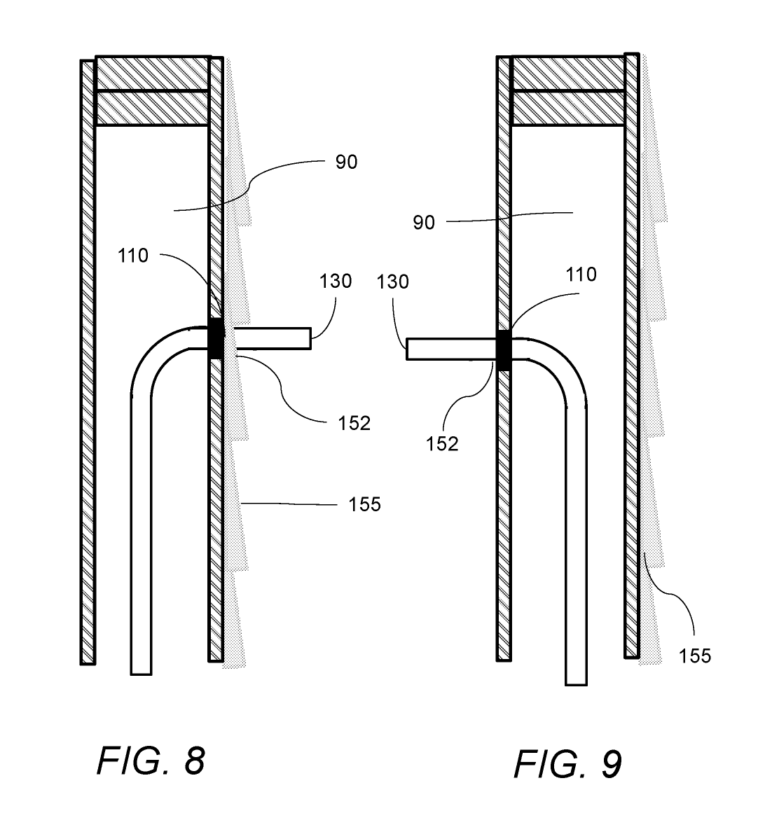

FIG. 8 and FIG. 9 illustrate two different ways that the repair of injection holes 110 is minimized. In FIG. 8, the point of injection 152 is on the exterior of a cavity 90 and is positioned under the lip of siding 155. When using closed cell foam, injection hole 152 doesn't require patching or repainting because the lip of siding 155 creates a shadow that hides the hole and because closed cell foam is waterproof and acts to seal the hole. When injecting from the interior of cavity 90, as shown in FIG. 9, the same hole 152 can be used with multiple dispense tubes 130 to direct foam to different locations within the cavity. Additionally, if injection hole 152 is kept smaller than ½″ in diameter, repair can be accomplished with a simple dab of spackle and spot repainting, rather than using a more complicated patching process and repainting of the entire wall.

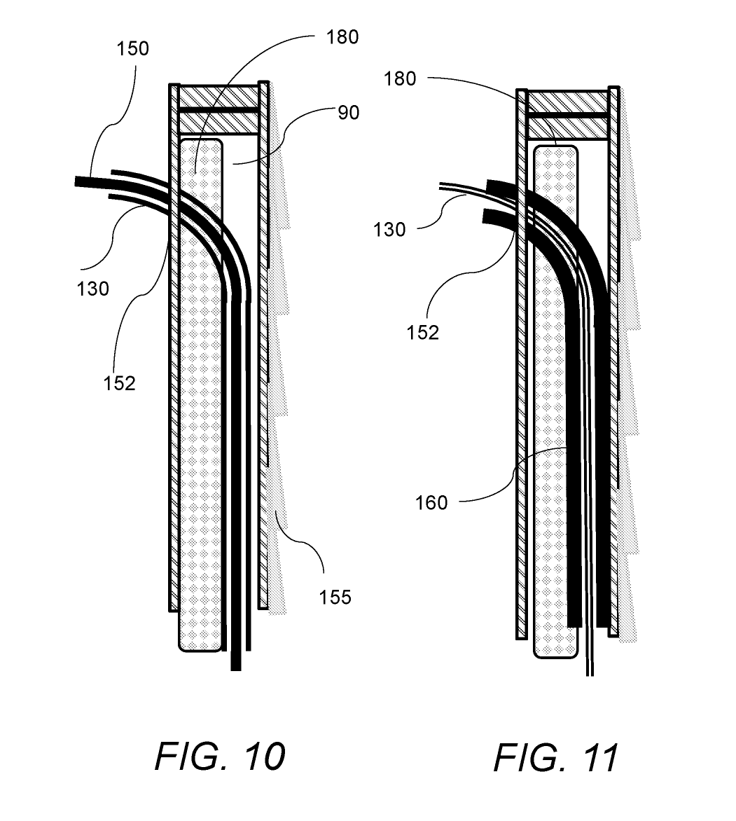

Referring to FIG. 10 and FIG. 11, when injecting from the interior of a building into cavities filled with fibrous insulation 180, dispense tubing 130 must pass through the fibrous insulation and remain to the exterior of the fibrous insulation 180. If the dispense tubing 130 is positioned to the interior of fibrous insulation 180, pressure from the expanding foam will cause the fibrous insulation 180 to compress on the outside of the cavity 90 where it could be subject to moisture accumulation and cause rot in the surrounding cavity sides. Since fibrous insulation 180 tends to wrap up in the threads of a drill bit, the injection holes should be drilled with the drill bit running counterclockwise (opposite the normal rotation). The drill bit must completely penetrate through the fibrous insulation 180 to the back wall of the cavity 90.

FIG. 10 and FIG. 11 illustrate two different ways that dispense tubing 130 is guided through the cavity from the injection hole 152. In FIG. 10, electrician's “fish tape” or “fish rod” 150 is inserted into dispense tubing 130 and then the combined dispense tubing 130 and fish rod/tape 150 are directed through the cavity by adjusting the angle of the fish rod/tape 150 from outside of the cavity. If there are many nails or other sharp obstructions within the cavity, tough semi-rigid guide tubing 160, as shown in FIG. 11, is positioned within the cavity first. Dispense tubing 130 is inserted into guide tubing 160, which guides dispense tubing 130 to the proper location and protects dispense tubing 130 from the sharp obstructions. In order to minimize the potential for clogging of guide tubing 160 with cured foam, a lubricant such as petroleum jelly, is applied to the inside of the tubing with a cotton swab. Alternatively, the tubing 160 is split apart lengthwise along a living hinge in order to clean out the cured foam.

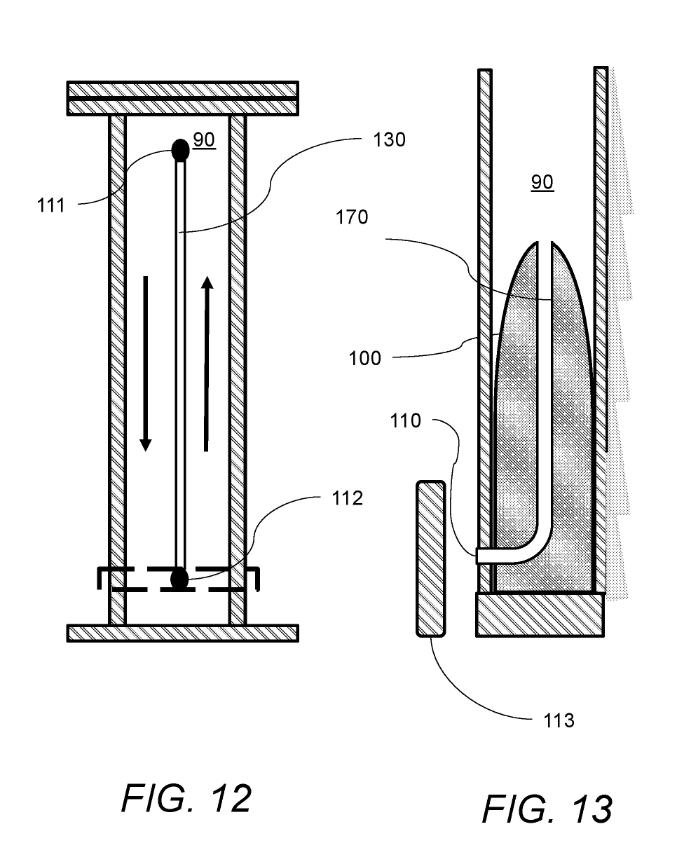

When traversing long lengths of a cavity, accurate positioning of dispense tubing 130 from the injection hole can be difficult, particularly when attempting to position dispense tubing precisely in the center of the cavity for a centering pattern of dispense. FIG. 12 illustrates an alternate method of precisely guiding dispense tubing 130 in the cavity. Fish rod/tape 150 is inserted in top hole 111 and threaded down to the bottom of the cavity. The fish rod/tape 150 is then caught in a bottom slot or hole 112 and positioned in the bottom center of the cavity. Dispense tubing 130 is then inserted over the fish rod/tape until it has traversed the entire length of the cavity. Once dispense tubing 130 is positioned, fish rod/tape 150 is withdrawn back up from the bottom hole or slot 112 to top hole 111. Fish rod/tape 150 is removed and dispense tube 130 is left in place in the center of the cavity.

FIG. 13 illustrates a method of entirely eliminating the need for dispense tubing 130 and, in many cases, eliminating the need to repair and repaint injection holes 110. Baseboard 113 is first removed from the bottom of the cavity 90. Several injection holes 110 per cavity are drilled in the bottom of the cavity in the former location of baseboard 113. Fish rod/tape 150 or guide tubing 160, lubricated with petroleum jelly or other similar release agent, is inserted in each of the injection holes 110. Each fish rod/tape 150 has the approximate height of a different lift of foam. Mixed partially expanded foam is then injected into the bottom of the cavity around all the lubricated fish rod/tapes 150. After hardening, the shortest fish rod/tape 150 is twisted and removed leaving an open tunnel 170 within the hardened mixed fully expanded foam 100. Mixed partially expanded foam is then injected through the tunnel to create the next lift. The process of removing fish rod/tape 150 and injecting subsequent lifts through tunnels is repeated until all lifts are complete and the entire cavity 90 is filled with mixed fully expanded foam 100. After the cavity is filled, baseboard 113 is replaced over the holes, thus eliminating the need to repair holes or repaint.

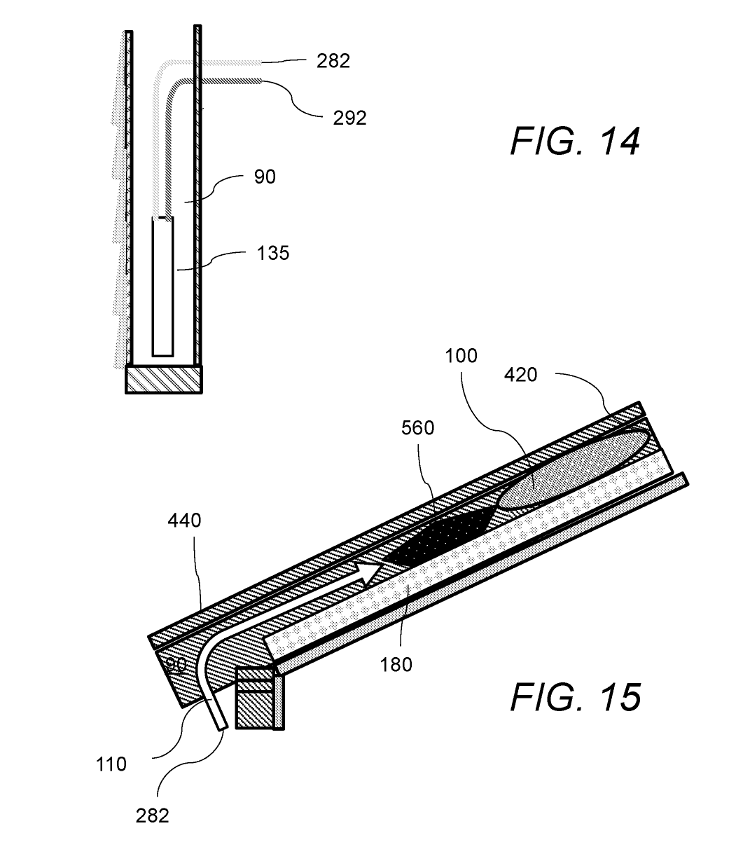

After foam chemicals A and B are mixed, they become sticky and more viscous and, as a result, flow becomes slower. This flow inhibition is particularly problematic when trying to flow foam through very long distances in cavities. Instead of mixing the foam components outside a cavity and then injecting a mixed substance through dispense tubing, mixing of the two foam components can be delayed until the two materials are deep inside the cavity. Because unmixed foam materials flow more easily than mixed materials, longer distances can be traversed inside a cavity without applying significant additional pressure. In FIG. 14, unmixed foam component A and unmixed foam component B are injected through separate material supply hoses 282 and 292, respectively, into the cavity 90 and only mix in mixing dispense tube 135 once inside the cavity. FIG. 15 is an elevation view of a cathedral ceiling closed cavity 90 formed under roof sheathing 440 and roof rafters 420. A dispense sled 560 rides on top of the fibrous insulation 180 and is connected to unmixed foam component B supply hose 282. The dispense sled 560 can be withdrawn intermittently or continuously as it dispenses material down the length of the cavity leaving behind the mixed fully expanded foam 100.

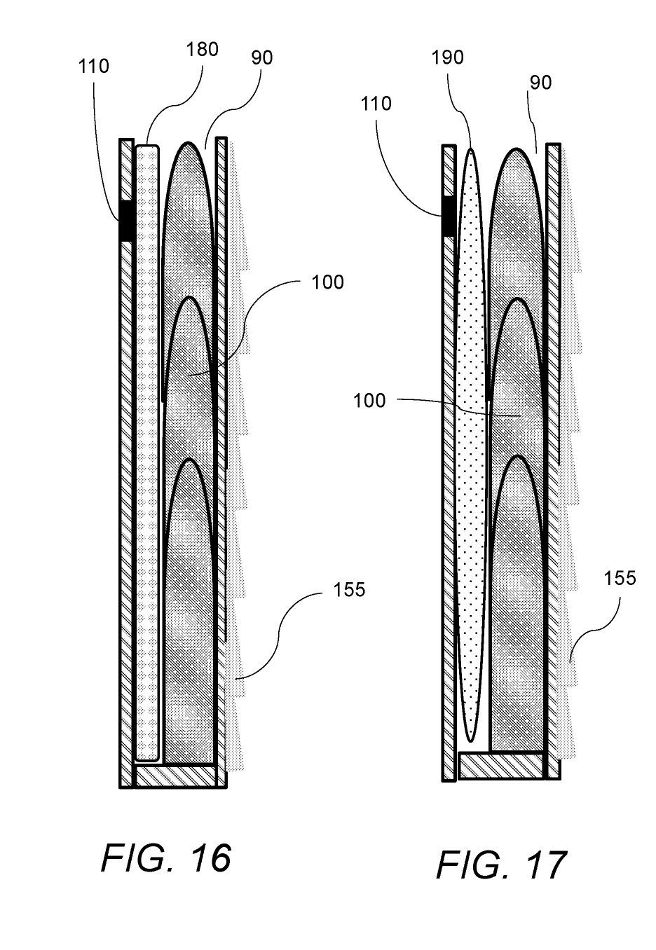

Referring to FIG. 16, when a cavity 90 is filled with fibrous insulation 180 and is injected from the inside, pressure relief holes 110 may be blocked off by the fibrous insulation. As a result, additional methods are required to reduce the potential for the expanding foam to blow out the walls of the cavity 90. As mentioned above, froth foams—which only expand 3 to 5 times their dispensed volume—are generally preferred to pour foams—which expand 30 times their liquid volume. In addition, as shown in FIG. 16, fibrous insulation 180 which has a very low compressive strength, may act to absorb much of the expansion.

Referring to FIG. 17, in the absence of fibrous insulation, other materials, such as a resilient bladder 190, may be inserted into part or the entire cavity 90 to help absorb some of the expansion. The resilient bladder 90 may contain insulating gasses, such as Argon, to further add to the insulation value of the structure.

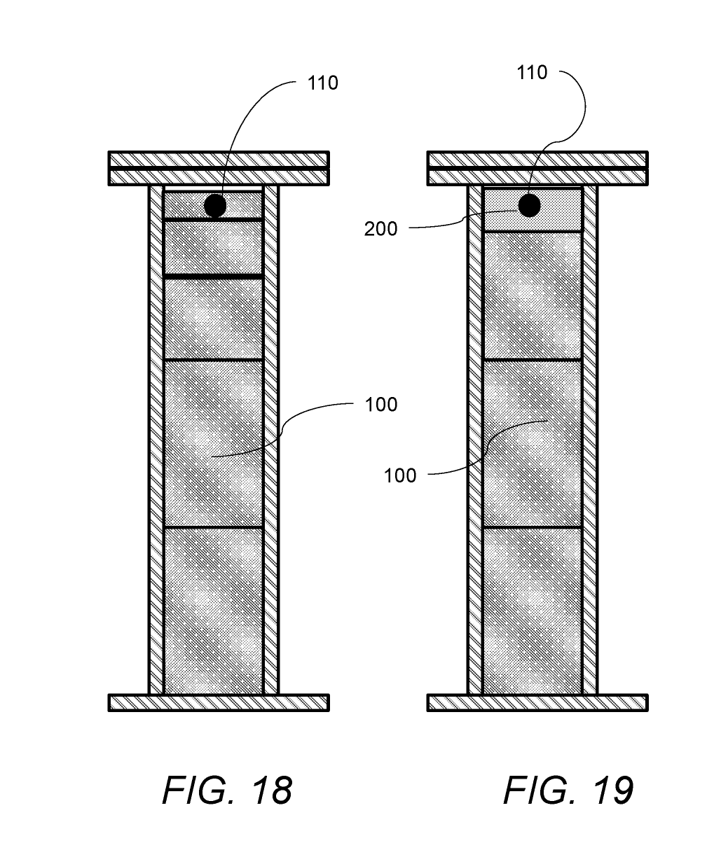

FIG. 18 and FIG. 19 illustrate two methods for reducing the probability of wall blowout using “finishing shots”. In FIG. 18, decreasing volumes of mixed fully expanded foam 100 have been deposited as the foam approaches the filling hole 110. This technique is referred to as “halving” because the timing of each subsequent shot is approximately half the time of the previous shot. Similarly, FIG. 19 illustrates a method of injecting a resilient foam, such as open cell foam 200, as the finishing shot. Open cell foams have very low compressive strengths and exert little pressure on cavity walls.

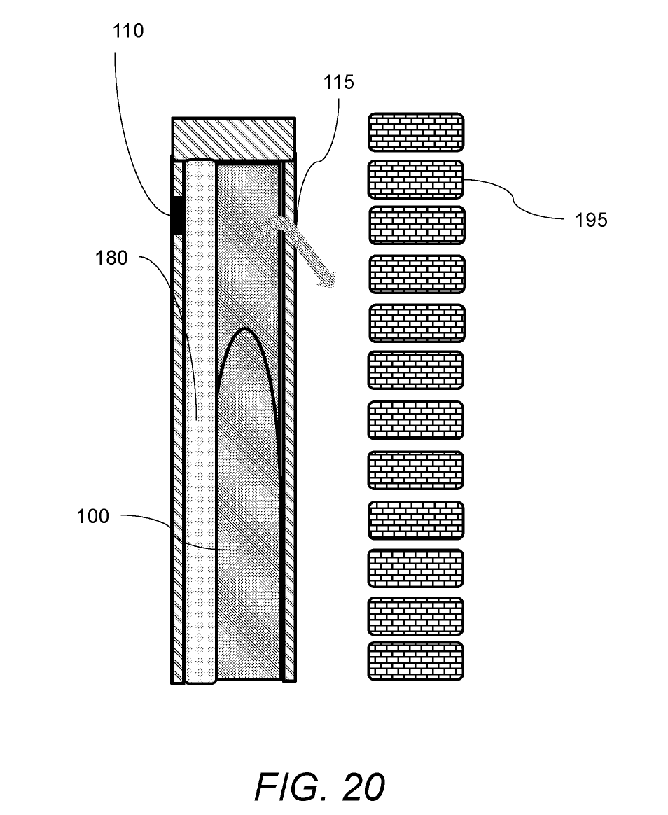

FIG. 20 illustrates a pressure relief method that works exceptionally well on cavity walls with an exterior cavity behind a veneer 195—as occurs with masonry veneer walls and some metal, vinyl, or aluminum veneer walls. In this method, an injection hole 110 is drilled through the interior cavity wall, through existing fibrous insulation 180 and through the exterior cavity wall.

As foam fills the interior of the cavity, excess partially expanded foam can drain out the exterior cavity wall through hole 115 behind the veneer 195.

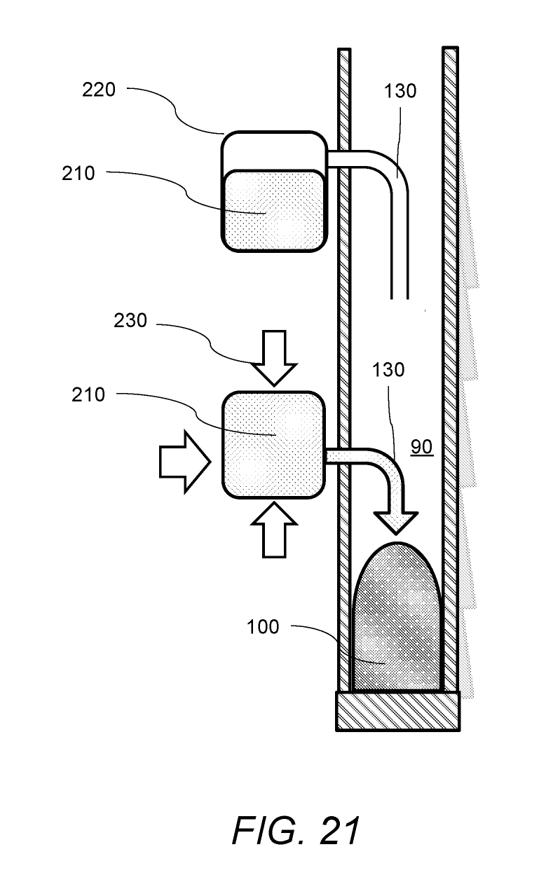

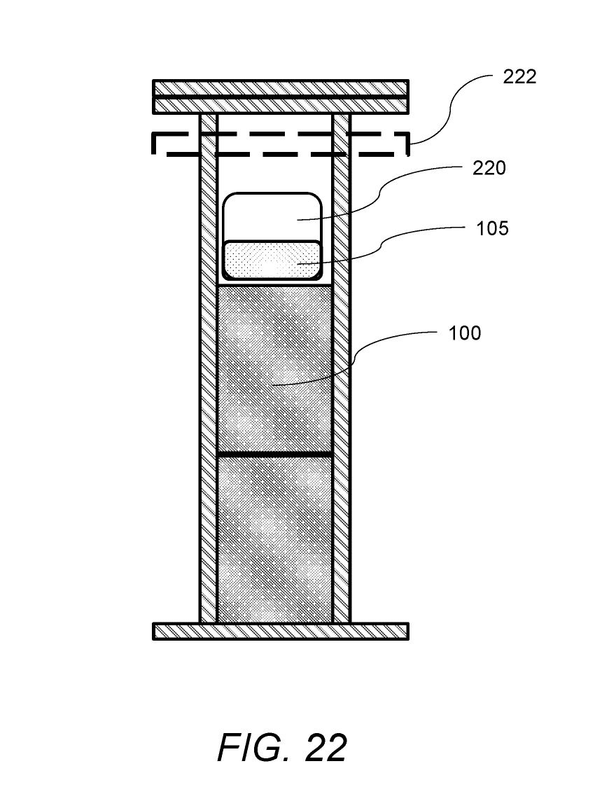

As mentioned above, pour foams are relatively easy to meter and package and cost about half as much as froth foams. FIG. 21 illustrates a method of pre-expanding pour foams so that that they can be used much like froth foams without all the cost and packaging difficulties of froth foams. As will be explained in detail later, a partially expanded pour foam 210 is mixed in a mixing bag 220 and is allowed to pre-expand to about 30-50% of its expected final expansion volume. At 30-50% expansion, the partially expanded pour foam 210 fills the mixing bag 220, overflows and self-extrudes through dispense tubing 130 into the cavity 90. After the pour foam stops expanding, and stops self-extruding, additional pressure 230 can be applied to the outside of the mixing bag 220 to completely empty any material than remains in the mixing bag. Additional pressure 230 can be applied manually or with pneumatic, hydraulic, mechanical, or other means. Rather than self extrude through a dispense tube 130, pour foams 210 can also be mixed in a mixing bag 220, pre-expanded and subsequently inserted through a slot 222 in the cavity prior to full expansion, as shown in FIG. 22. The pour foam then completes its expansion within the cavity.

### System Components

The overall injection foam system is composed of materials, material packaging, material supply hoses, a dispense gun, gun nozzles, a mixing system, a metering system, dispense tubes, tube guiding devices, fittings to connect the various components and means of applying pressure to the materials in order to dispense the materials into the cavity. The inventions described in this section pertain to all these components with the exception of materials, material supply hoses and dispense guns.

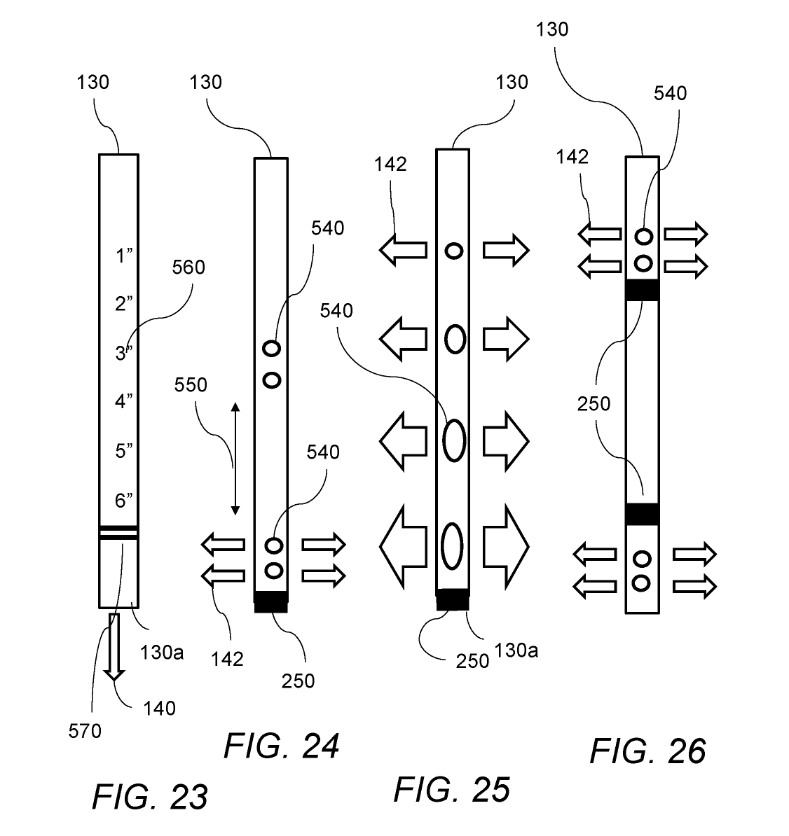

FIGS. 23, 24, 25 and 26 show dispense tubes 130 with various dispense directions 140, 142 and various tube sealing locations 250. FIG. 23 illustrates a simple dispense tube 130 with an open end 130a and dispense direction 140 parallel to the tube. This type of tube is primarily used in an alternate pattern dispense. FIG. 23 also illustrates markings, such as ruled markings 560 and a “stop” marking 570, applied to the tube to help the operator determine how far to withdraw a tube during intermittent or continuous withdrawal dispense.

FIG. 24 illustrates a tube 130 with tube seal 250 at one end and holes 540 in the side that cause dispense direction 142 to be approximately perpendicular to the length of the dispense tube 130. Holes 540 may be at just one end of the tube, or may be positioned along the entire length of tube 130 at regular spacing, or may have different diameters or may be spaced at different intervals 550. This type of dispense tube is primarily used in a centering pattern dispense.

FIG. 25 illustrates a dispense tube 130 with tube seal 250 at end 130a of the tube and with holes 540 of varying diameter from one end to the other. This type of dispense tube is used for simultaneous dispense of material through the entire cavity at once, as shown in FIG. 5. In one example, hole sizes can be designed to equalize flow of material out of the entire length of the tube at once. FIG. 25 illustrates one pattern in which hole sizes near the closed end of the tube are larger than hole sizes at the opposite end of the tube. Flow is equalized because the pressure driving material out of the tube is lower near the closed end of the tube than at the opposite end. However, the pattern of holes can be reversed in some cases due to backpressure and other forces specific to the materials being dispensed. Simultaneous dispense enables one shot to fill an entire cavity and is much faster than multiple shots.

FIG. 26 illustrates a dispense tube 130 with multiple tube closures 250 along the length of dispense tube 130. This type of tube is used to enable a single dispense tube 130 to be injected from two or more dispense holes 110, as shown in FIG. 4. Injecting from both a top and bottom hole can cut the distance foam must travel in the tube and thus improve sideways dispense force and thickness control.

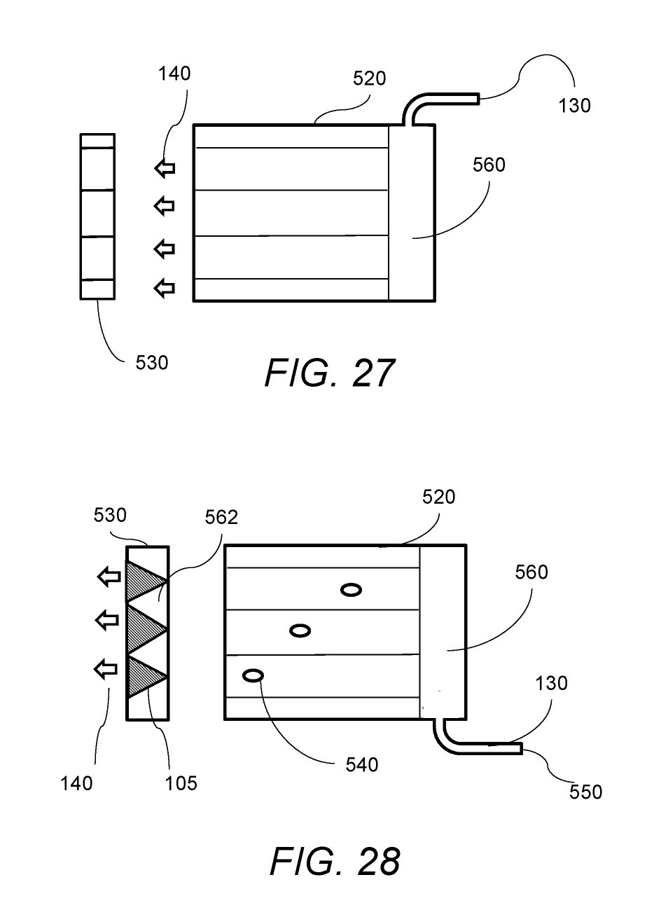

In certain applications it can be advantageous to use a multiwall dispense tube 520. FIG. 27 illustrates a multiwall dispense tube 520 with vertical walls in which foam is injected through dispense tube 130, spreads through distribution manifold 560 across the entire baffled tube 520 and is dispensed out the end in dispense direction 140. This multiwall dispense tube is used in applications requiring simultaneous dispense and is used as a substitute for a centering dispense pattern when a faster dispense is desired. FIG. 28 illustrates a multiwall dispense tube 520 with angled walls in which foam is injected through injection location 550, spreads through distribution manifold 560 and is dispensed out injection holes 540 in dispense direction 140. Baffles 562 that are not used for dispensing foam are filled with a pressurized gas to rigidize the baffled dispense tube 520. A rigidized baffled dispense tube 520 is particularly useful to serve as a second cavity wall in open cavities that have only one wall. It may also be used in sloped cavities, as will be described in detail later. Manifold 560 is designed to enable all channels within the multiwall tube to fill simultaneously. In other embodiments, manifold 560 is designed to enable each channel to be filled in sequence.

The various conventional mixers used to mix two component insulating foams, and other two component chemical systems, are all problematic. Static mixers in particular must either be purged regularly, requiring complex connections to purging materials, or must be replaced after every 30 seconds of non-use due to clogging. A major advantage of using dispense tubes is that the dispense tube can also act as a mixer—eliminating a problematic part of the system. When the two components of foam are dispensed together in close proximity through a tube of 1.5 feet or longer, the blowing agent in the foam will cause the two components to intermingle and mix as they traverse the dispense tube.

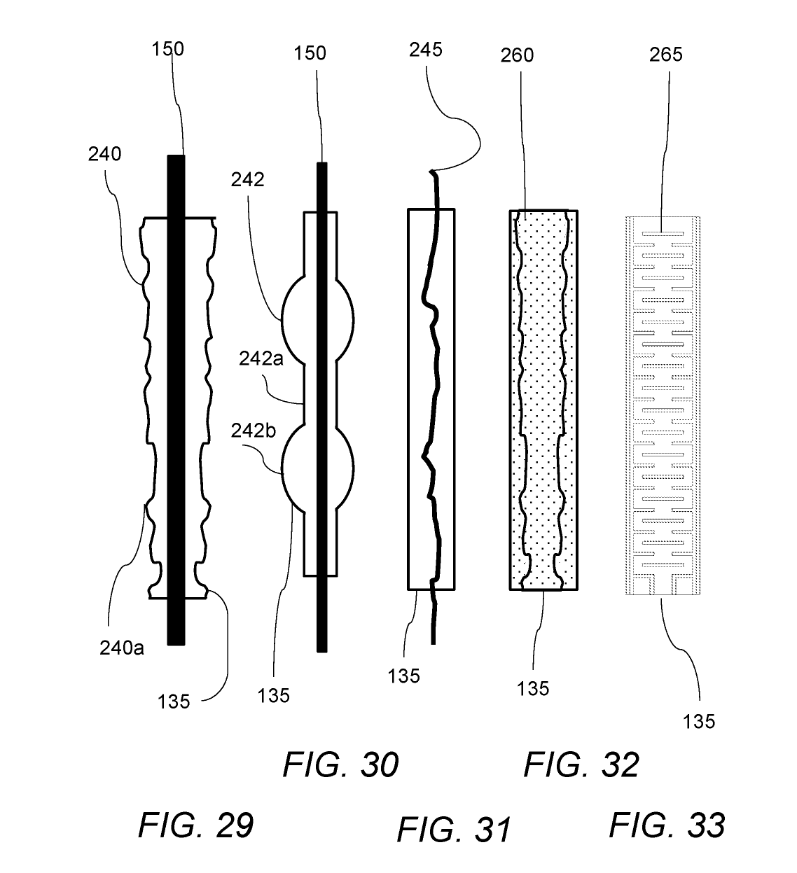

When gaseous blowing agents are used, the materials will mix without any additional processing. When liquid blowing agents are used, the two components require either additional heat to activate the blowing agent or a tube design that promotes intermixing and/or the addition of nitrogen or other gas to create nucleating bubbles. FIGS. 29, 30, 31, 32, and 33 illustrate 5 different tube designs that further promote intermixing of the two chemical components. FIG. 29 illustrates a method of inserting a rod 150 into shrink tubing 240 to create a semi-rigid tube with rough walls. When heat is applied, the shrink tubing shrinks around the rod 150. If the diameter of rod 150 is less than the diameter of the shrink tubing 240 after the tubing has been heated and shrunk, the shrink tubing will create a rough outer surface 240a. As the two components of foam travel through the mixing dispense tube 135, the rough surface of the sides of the tubing creates eddies, vortices and other perturbations to the flow. These perturbations cause the two components to mix as they travel through the tubing. Shrink tubing 240 has the added advantage of very low cost (approximately 1/100^{th} the cost of other forms of tubing). This low cost allows it to be used only once and left in the cavity as a disposable item thereby greatly simplifying cleanup.

Since thicker shrink films don't create as rough a surface as thin shrink films, an alternative method of creating a mixing tube using shrink film is to intermittently shrink the film. This results in alternating narrow and wide areas 242a, 242b, as illustrated in FIG. 30. Mixing occurs as material passes through the alternating widths of the tube. If the tubing material is highly flexible, such as with polyolefin heat shrink materials, the unshrunk areas have the added advantage of being kink free zones.

FIG. 31 illustrates a method of using a mixing string 245 to create perturbations to flow and resultant mixing. As the two components of the foam pass over the string 245, the rough surface of the string causes the string to wave back and forth in the flow. This waving action disturbs the flow and causes the two components of foam to mix. To maximize this effect, the string 245 may be knotted, creating even larger flow perturbations.

FIG. 32 illustrates a porous tube 260 with a rough inner surface. The rough inner surface of the porous tube disturbs and mixes the two flow streams in much the same way as the shrink film 240 illustrated in FIG. 29. The porous tube 260 may be coated on the outside to keep mixed foam from escaping from the sides of the tube. In other embodiments, the porous tube 260 is partially or completely uncoated to allow foam to escape from desired areas of the tube. Porous tubes 260 may be composed of punched layflat tubing, as used for bakery items, or of porous vinyl or similar materials, as used in the fabrication of soaker hoses and drip irrigation equipment.

FIG. 33 illustrates a flat two dimensional patterned mixing tube 135. The complex flow channel 265 in this tube causes the two components to split and recombine much as in a standard static mixer. However, two dimensional embossing and heat sealing is much less expensive than the three dimensional plastic molding required for standard static mixers. Patterns 265 may be fabricated from die cut double sided adhesives, pattern coated adhesives, embossed films, or a patterned heated die. These patterns may be laminated between layers of inexpensive cover films and incorporated into part or all of a dispense tube.

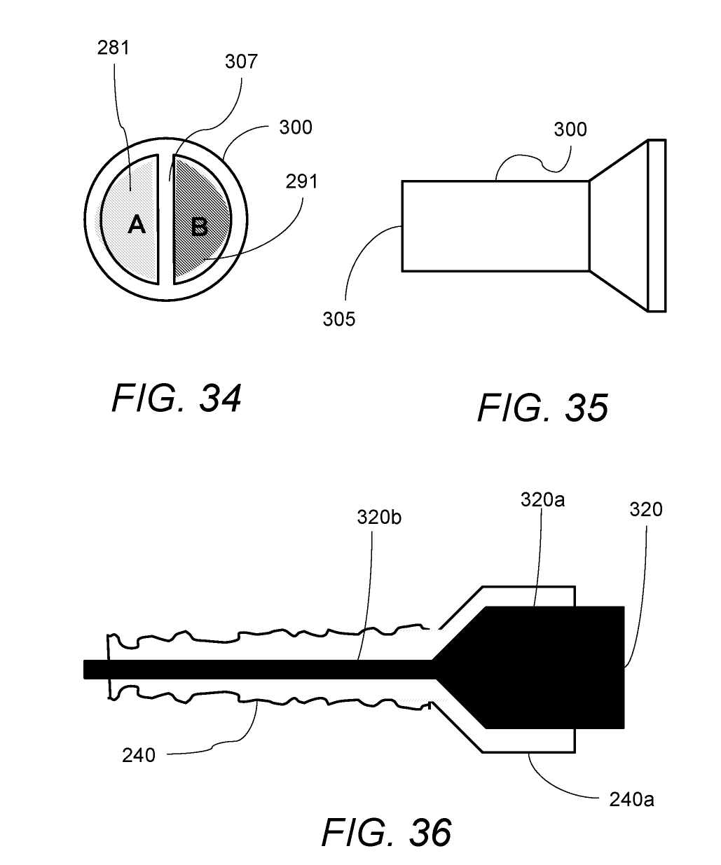

In order to contain a standard static mixer within a nozzle, conventional nozzles have openings that are narrower diameter than the static mixer diameter. These openings are typically less than ⅛″. However, this narrow diameter opening causes significant backpressure and resultant slowing of foam flow. Foam dispense distance is extended by using a nozzle 300 with a wide diameter opening 305, as shown in FIG. 35, that is greater than ⅛″. The elimination of static mixers also enables the nozzle 300 to be divided by divider 307, as shown in FIG. 34. Divided nozzles enable foam component A 281 to remain separate from foam component B 291. Because the two components remain unmixed, curing doesn't occur and the nozzles don't clog up every 30 seconds or require complex purging connections as with conventional nozzles.

Rather than a three piece dispense system composed of gun, nozzle and dispense tubing, a two piece dispense system may be used, as shown in FIG. 36. Shrink tubing 240 is heat shrunk around a rod 320 with a wide diameter portion 320a and a narrow diameter portion 320b. Once the rod 320 is removed, the wide diameter end of the shrink tubing 240a is fit and clamped directly over the face of the gun. Foam flows directly from the wide end of the shrink tubing into the narrow end without the need for a nozzle.

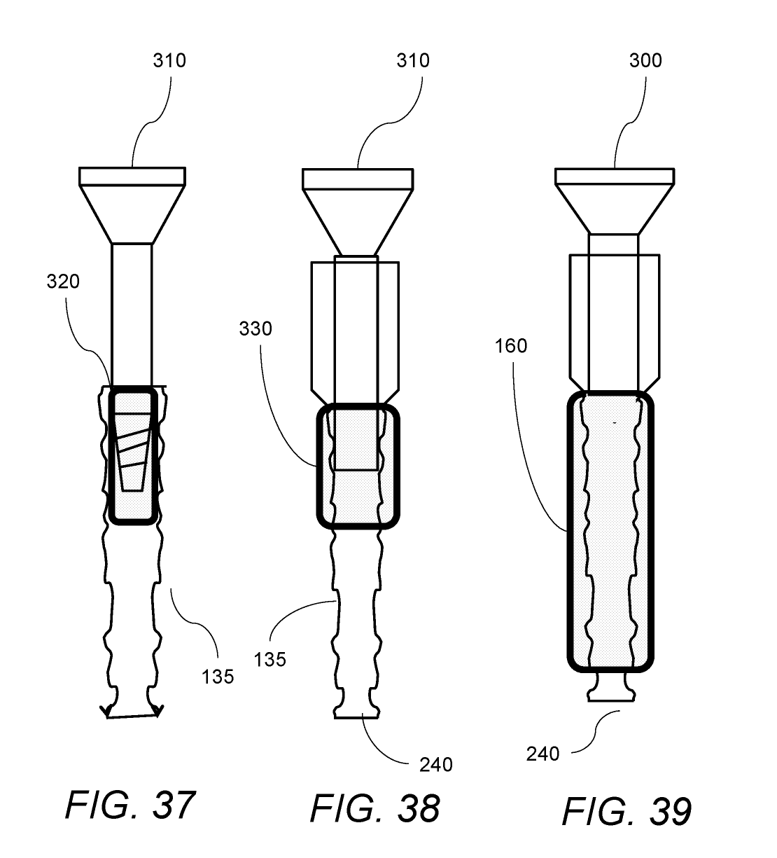

FIGS. 37, 38, and 39 illustrate three methods of attaching a mixing dispense tube 135 to a narrow threaded nozzle 310 or to a wide nozzle 300. In FIG. 37, nozzle 310 is screwed into a conformable stub 320 formed within a mixing dispense tube 135. This method offers a secure and simple attachment without any additional components. In FIG. 38, an external connector 330 such as an external compression nut, hose clamp or push to connect fitting is screwed, slid or tightened over mixing dispense tube 135 and nozzle 300 to create a leak-proof connection. Nut 330 compresses mixing dispense tube 135 against the nozzle 310 creating a secure and leak-proof connection. To enhance the leak-proofness of this design, a resilient material, such as flexible PVC tubing, may be attached to the nozzle under the area of compression. This method is secure and enables a simpler fabrication of dispense tube 130. In FIG. 39, a shrink film dispense tube 240 with a wide opening, as illustrated in FIG. 36, is compressed between wide diameter nozzle 300 and guide tube 160. Because this method doesn't require a third component and allows for a simple dispense tube fabrication, it combines the advantages of the embodiments in FIG. 37 and FIG. 38.

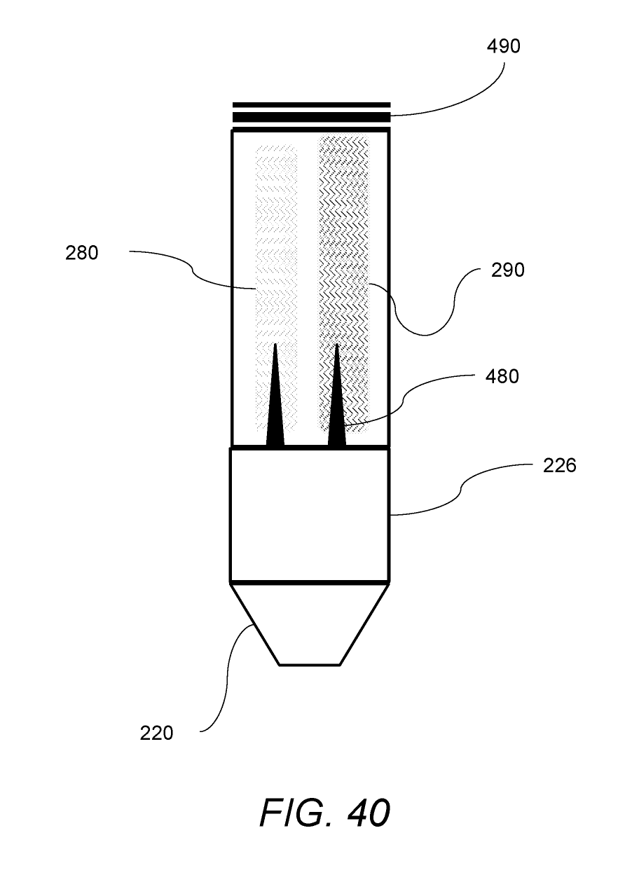

As was described above, the use of pre-expanded pour foams may offer cost and performance advantages over froth foams. FIG. 40 illustrates a mixing bag 220 for mixing flexible packaged pour foam A 280 with flexible packaged pour foam B 290. Pour foam A 280 and pour foam B 290 are first inserted into mixing bag 220. A press fit bag closure 490, such as a Zip-loc closure, is then closed and the two components 280 and 290 are forced against piercing devices 480. The two components drain into mixing area 226 where they are mixed by external agitation. Examples of external agitation include hand kneading, mechanical kneading and spin mixing. As described above, once thoroughly mixed, the two components are allowed to pre-expand to 30-50% of their expanded volume before either self-extruding into the cavity, as shown in FIG. 21, or being placed in the cavity through a slot and allowed to expand, as shown in FIG. 22.

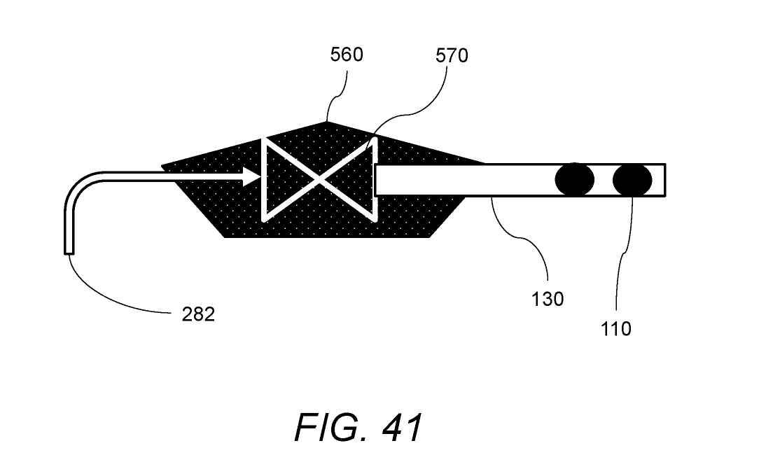

As was described above with reference to FIG. 14 and FIG. 15, for long cavities it may be advantageous to delay the mix and dispense of materials until the mixer is deep in the cavity. FIG. 41 illustrates a remote dispense sled 560 with trigger valve 570 component A supply line 282, dispense tubing 130 and dispense holes 110. The sled 560 is designed to slide easily on the top of fibrous insulation and below nails protruding from roof sheathing as it is pushed deep into a cavity. Once positioned at the proper location, the trigger valve 570 is remotely activated and mixed partially expanded foam flows through dispense tube 130 and out holes 110.

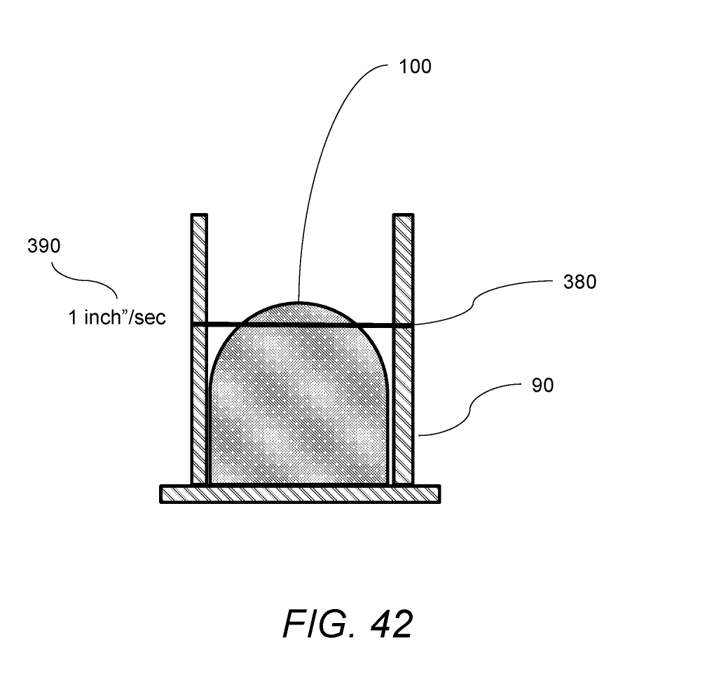

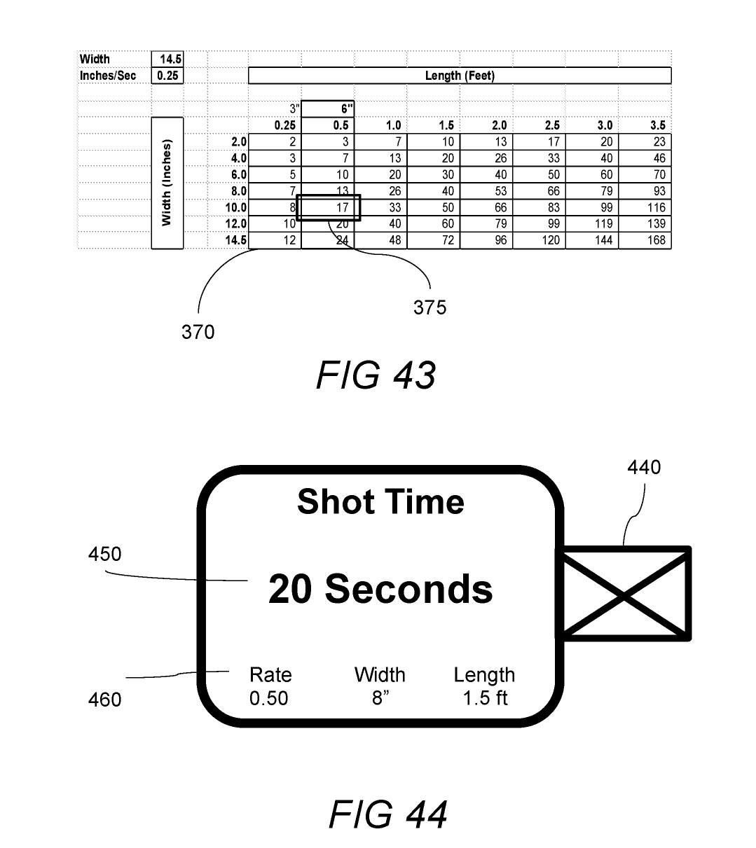

Because overfilling of cavities can cause blowout of cavity walls, foam metering is critically important. Foam expansion is heavily dependent on many factors difficult to control in field environments such as substrate moisture, ambient humidity, ambient temperature, cavity width, fibrous insulation composition and, most importantly, variations in pressure in disposable pressure vessels. In order to accommodate all these variables, an in-wall metering process is used. As illustrated in FIG. 42, in this process a mixed partially expanded foam is dispensed into a cavity 90 of known width for either a known amount of time or with a known volume of material. After the dispensed material has fully expanded, the average rise height 380 of the foam is measured using an infrared camera. The rise height is then divided by the dispense time or dispense volume to determine a dispense rate 390. The dispense rate can, in turn, be used to determine the amount of time or volume of material needed to fill a cavity to a known height. For instance, if a 10 second dispense time rises 10 inches in a 12 inch wide cavity, a 1 inch per second rise is to be expected in all 12 inch wide cavities. Accordingly, if a 20 inch rise height is desired, a 20 second shot of foam would be dispensed. Similarly, in a cavity 6 inches wide, a 10 second shot would be dispensed to achieve a 20 inch rise. It should be noted that for large dispense volumes, typically 18 inches of height in a standard 14.5 inch wide cavity, the fill rate will be an approximation. This is due in part to a more significant exotherm of the mixed partially expanded foam which causes rise height to be somewhat nonlinear. Shot timing is determined using a shot timing table 370, as illustrated in FIG. 43. For instance, if the in wall metering process indicates a 0.25 inch per second dispense rate, and one wanted to fill a 10 inch wide cavity 6 inches high, a shot time 375 of 17 seconds would be used. In other embodiments, rather than using a shot timing table 370, a digital or analog shot timer 440 attached to a control valve and display is used, as shown in FIG. 44. The rate, cavity width and cavity length are entered into the display and the shot time is calculated. An automatic shutoff valve 440 shuts off flow after the shot time has been achieved to eliminate possibilities for human error.

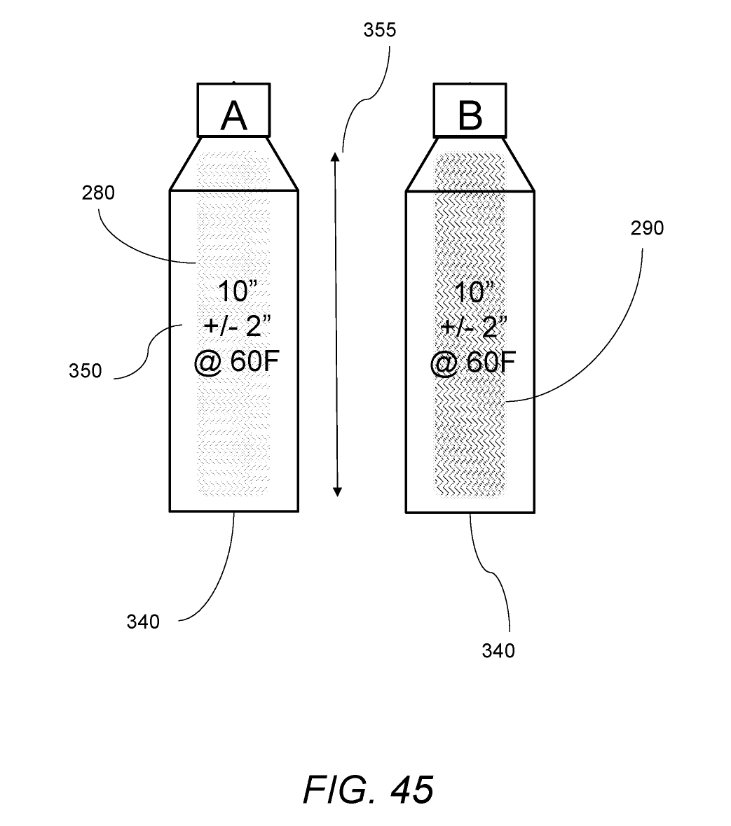

To entirely eliminate the need for complex metering systems, controlled dose packaging 340 is used, as shown in FIG. 45. An appropriate volume of the controlled dose package is determined for various width and length cavities e.g. a 14.5″ wide standard cavity package might contain one liter of material while a 7″ wide cavity package might contain 0.5 liters of material. During shipping the two components of foam are kept separated to avoid inadvertent mixing and expansion in the transport vehicle. When using pour foam in a flexible package, unmixed component A 280 is highly moisture sensitive and unmixed component B contains a blowing agent that can expand significantly if subjected to shipping temperatures in excess of 120° F. Thus both components are packaged in moisture proof and leak-proof containers. In FIG. 45, component A 280 is packaged in a separate container 340 from component B 290. The flexible packaging around components A and B serve as a liners for moisture and leak-proof containers 340, keeping the containers 340 free of chemical and allowing the containers to be re-used.

Containers 340 may be labeled, color coded and sized to further simplify foam metering. For instance, the length 355 of the flexible packaging may be approximately the same length as the expanded height of the foam in a standard 14.5″ wide×3.5″ deep cavity. Furthermore, the label 350 may indicate the rise height, and variation in rise height, at a given temperature in a standard cavity.

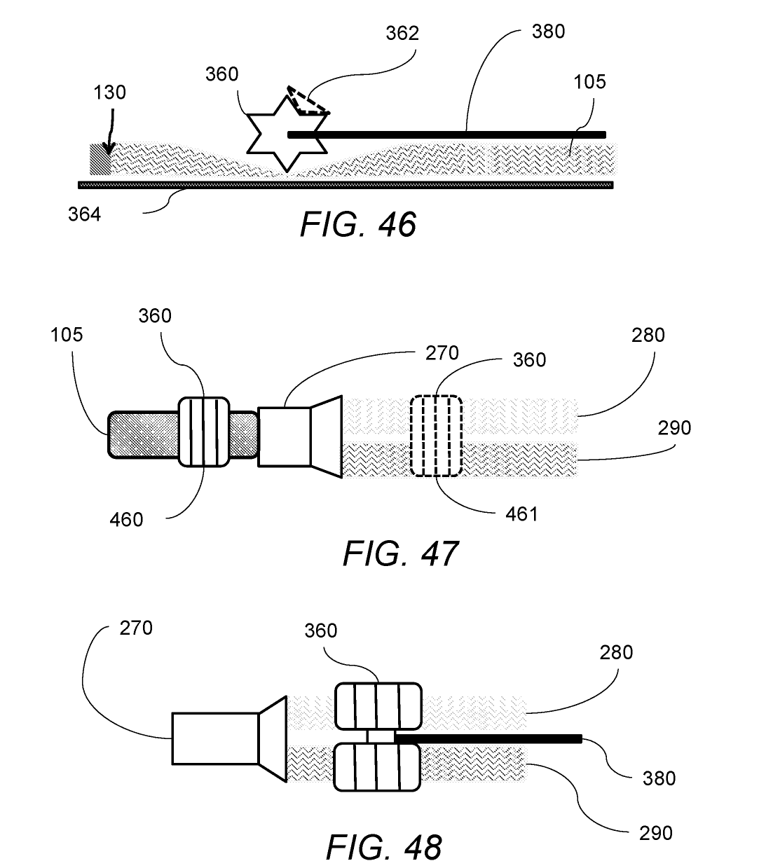

An alternative to controlled dose packaging or a metering box is a peristaltic pump. Referring to FIG. 46, in one variation of a peristaltic pump, a metering wheel 360 contains indentations 362 of known volume. As the indentations compress either a flexible package of foam 290 or a flexible dispense tube 130 against an opposing surface 364, a known amount of liquid or foam fills the indentations 362. Thus the number of rotations of the metering wheel is converted into a known amount of liquid or foam dispensed.

Peristaltic pumps are normally driven externally. If a peristaltic pump is composed of two metering wheels 360 that share a common axis, as shown in FIG. 48, then the amount of foam component A 280 and foam component B 290 will be metered and will be dispensed in a precise 1:1 ratio.

FIG. 48 also illustrates an electric or pneumatic caulk gun that is retrofit to dispense foam. In this case, a metering wheel 360 is driven by a piston 380 on the caulk gun to squeeze flexible packaged foam out through a mixing chamber 270.

Alternatively, a peristaltic pump may be self driven without requiring any external mechanical or pneumatic device. As shown in FIG. 47, the metering wheel can be placed either in a position after the mixing chamber 270 (position 460) or before the mixing chamber 270 (position 461). If placed after the mixer, the metering wheel will rotate and meter foam simply through the pressure of the mixed partially expanded foam 105 on the points of the metering wheel 360. If placed before the mixer, the pressure of material in the supply hoses, typically around 120 psi, will drive the material through the metering wheel 360.

### Materials

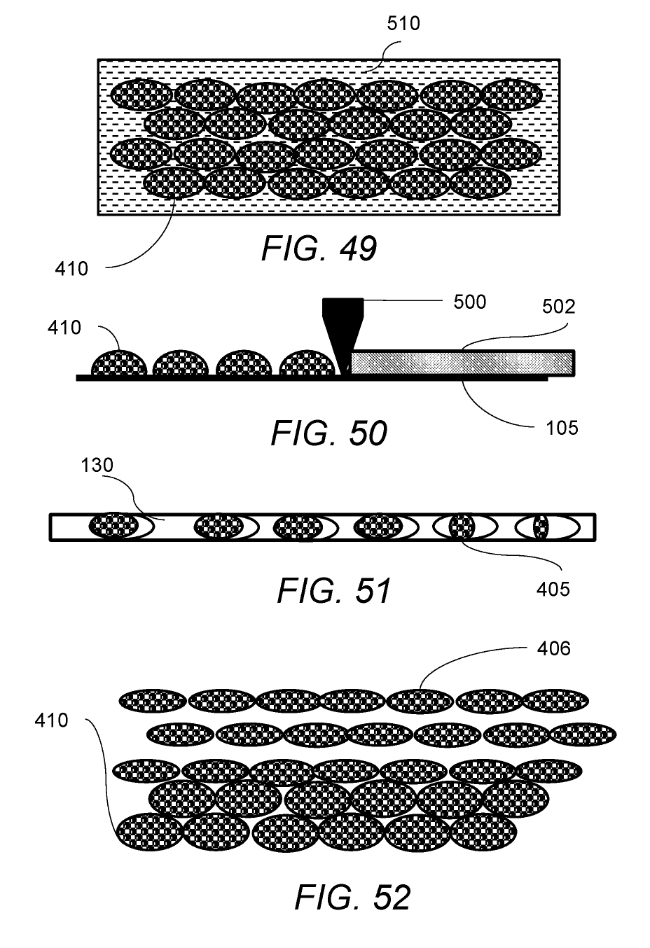

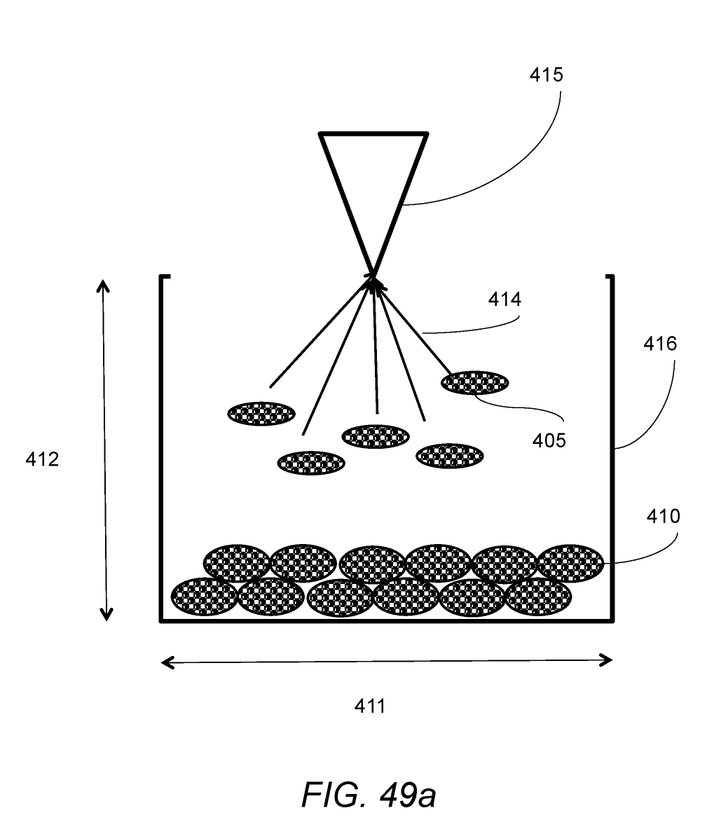

One method of virtually eliminating the potential for expanding insulating foam to blow out walls is to use foam that doesn't expand. FIG. 49 illustrates pre-cured fully expanded beads of insulating foam 410 suspended in a binder 510. Because the beads 410 can be produced from standard highly insulating foams, the insulation value of the mix is maintained. Because the binder fills the spaces around the pre-cured fully expanded beads, the air sealing properties of the insulating foam are also maintained. In some embodiments, the binder is manufactured from vapor retarding materials, and the low permeability of the insulating foam is also maintained.

A simple method of forming pre-cured beads 410 is by cutting large pre-cured boards of insulating foam into small beads. In this case, the beads are cut small enough to fit through injection holes in the cavity. A major advantage of this method is that foam boards, such as polyisocyanurate, with very high insulating value but very low cost (and very low global warming potential), can be used.

In another embodiment, pre-cured beads 410 are manufactured by an intermittent dispense in droplets. In one case, a one or two component insulating foam is dispensed through a solenoid valve that rapidly opens and close. These valves, sometimes called “valve jets”, are capable of handling much higher viscosity material than ink jets. In another case, droplets are formed using a standard spray foam gun. As illustrated in FIG. 49a, in both cases material is dispensed from a gun 415 in a container 416 with a size that allows the beads to fully cure before coming into contact with the walls or the floor of the container or with neighboring partially cured beads 405. For example, as illustrated in FIG. 49a, a container has a width 411 wider than the width of spray pattern 414. The height 412 of the container is determined by the time is takes for the beads to become tack free e.g. if the tack free time is 30 seconds, the height 412 will great enough to enable the beads to fall through the container for 30 seconds so that they land in the bottom of the container without significant adhesion to neighboring beads.

A major concern of using pre-cured beads of insulating foam is that the blowing agent, which provides most of the insulating value of insulating foam, will rapidly diffuse through the polymer matrix due to the very high surface area of the beads. In order to address this issue, the beads may be coated with a material that inhibits diffusion of blowing agent. Vapor coated metallic or ceramic coatings greatly reduce diffusion of blowing agents through the polymer. Nanoscale graphite also inhibit diffusion of blowing agent and have the added advantage improving the insulation performance of the material by disrupting radiant heat transfer. Polymeric coatings, such as polyurethane, which have lower thermal conductivity than metallic coatings, may also be used to inhibit diffusion of blowing agent. Polymeric coatings applied as a liquid or spray have the advantage of low cost and simplicity compared to vapor coated metals or ceramics.

An alternative method of fabricating pre-cured beads to contain blowing agent is illustrated in FIG. 50. In this method, mixed partially expanded foam 105 is partially cured in a narrow polymeric tube 502. Prior to completion of cure, a heat sealer 500 seals the tube at intermittent spaced locations. As the foam completes its expansion within the sealed polymeric tube, it stretches the tube to create a bead 410. Beads are formed when the tube is cut at the heat seal locations. The polymeric film serves as an excellent encapsulant for the blowing agent in the pre-cured beads 410.

Binder 510 may be manufactured from a wide variety of adhesives or foams including polyurethane, epoxies, acrylates, latexes, and silicones. Of particular interest is the use of adhesives such as silicones that provide additional fire retardant properties to the pre-cured beads 410 and that are proven as insulation binders.

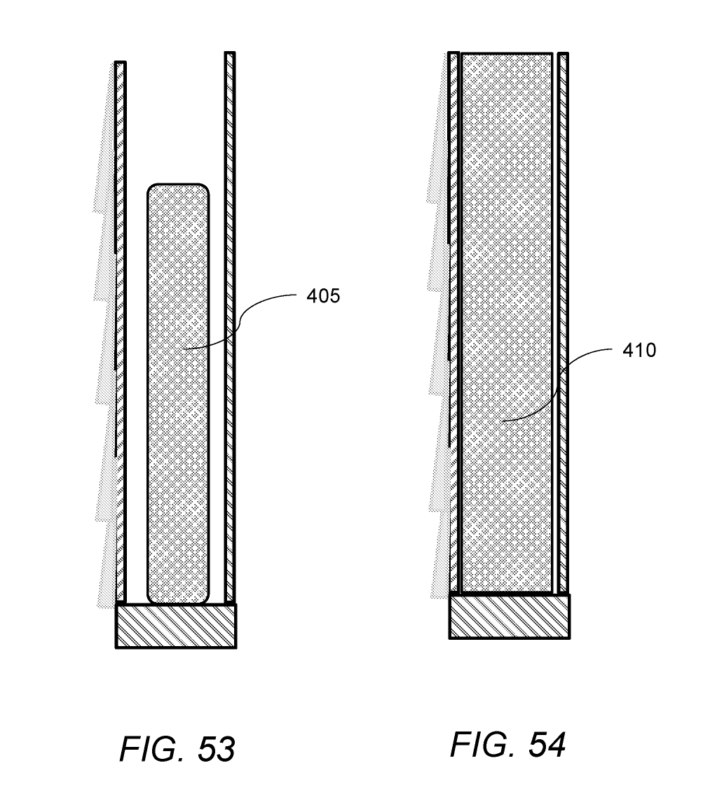

Rather than use a binder, which takes time to cure and which adds to the complexity of the dispense equipment, insulating beads 410 may be designed to expand within the cavity—entirely filling the air spaces between the beads and thus eliminating the need for a binder. FIG. 53 shows unexpanded insulating beads 405 within a cavity. FIG. 54 shows expanded insulating beads 410 entirely filling the cavity.

One method of creating unexpanded beads is to compress fully expanded pre-cured beads prior to injection into a cavity. For instance, as shown in FIG. 52, beads 406 are rolled into a narrow diameter “sausage shape”. The narrow diameter is injected through narrow diameter injection holes into the cavity. Once inside the cavity, the beads expand and recover their original shape filling the cavity. Foam materials with very slow recovery, such as “memory foams” can be used.

FIG. 51 illustrates a method of dispensing partially cured insulating beads 405 into a heat sealed tube 130. Rather than allowing the insulating foam to fully expand prior to cutting into beads, the partially expanded insulating foam is heat sealed, cut, and immediately dispensed into the cavity. Once inside the cavity, the insulating beads fully expand to eliminate air gaps and fill the cavity.

### Applications

One of the primary applications of the injection process is for retrofit injection of closed vertical wall cavities i.e. wall cavities that have 4 sides and 2 walls and that are accessible only through injection holes, as shown in FIG. 1 and FIG. 2. However, the injection processes and components described herein have advantages in many additional applications including open cavities and non-vertical applications. As will be described below, these applications include basement walls, roof rafters, cathedral ceilings, attic floors, kneewalls and between floor rim joists. The processes and components can also be used for both new construction and retrofit construction and as a process to make insulation products molded within a cavity.

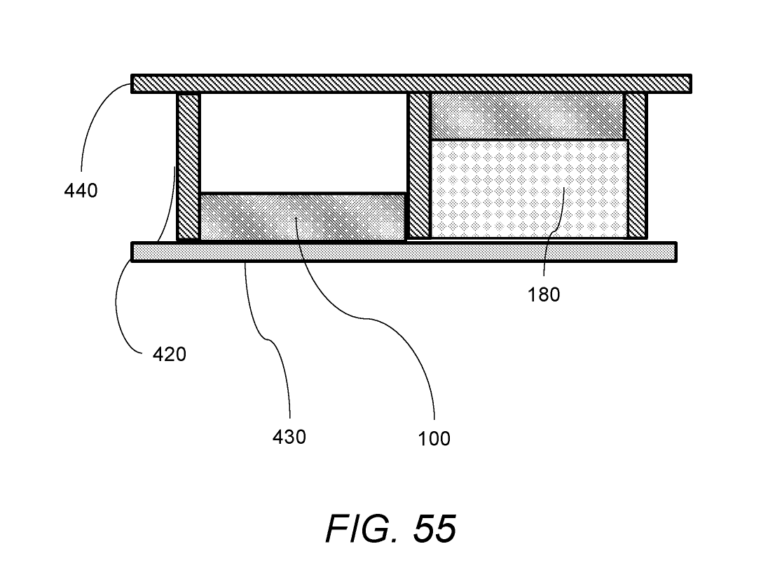

As shown in FIG. 15 and FIG. 55, closed horizontal or sloped cavities, such as in cathedral ceilings or flat roofs, can be injected using the same methods as the vertical wall cavities described above. FIG. 55 is a cross sectional view of a cathedral ceiling with roof sheathing 440, roof rafter 420, ceiling 430 and fibrous insulation 180 in the right hand bay. Mixed partially expanded foam is injected either above the fibrous insulation 180 or, if the bay is empty, above the ceiling 430. It should be noted that in cathedral ceiling applications without a pre-installed vapor barrier, building codes require the use of a closed cell foam installed to the exterior (or above) any pre-installed fibrous insulation. FIG. 15 is an elevation view of a cathedral ceiling illustrating foam 110 being injected from injection hole 110 and filled in lifts 560 running from bottom to top of the cavity. In cathedral ceilings with a low slope, injection foam tends to create mounds or uneven thicknesses when installed in lifts. In order to alleviate this problem, a continuous extrusion, as illustrated in FIG. 5 and described above, can be used to better control insulating foam thickness. Alternatively, delayed dispense using a remote dispense sled as described above could be used.

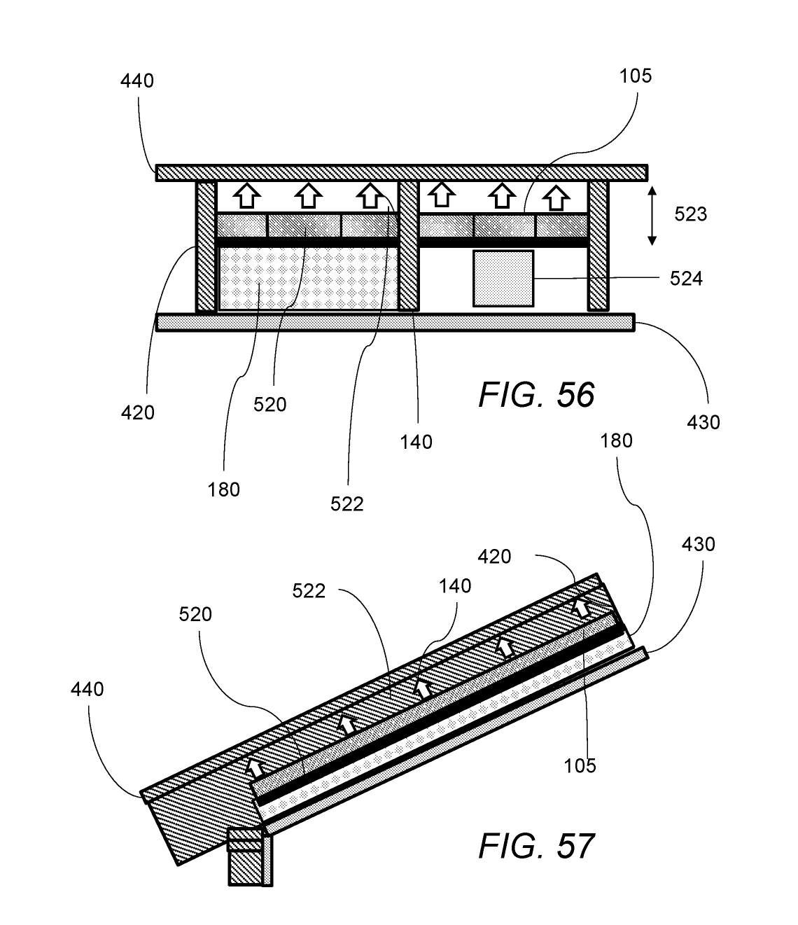

FIG. 56 and FIG. 57 illustrate a method of controlling thickness in low slope cathedral ceilings using a multiwall dispense tube 520. In this method, a semi-rigid guide sheet 522 is first installed into the cavity at a distance 523 from the roof sheathing 440 that corresponds to the desired thickness of foam. If the cavity is filled with fibrous insulation 180, as shown on the left, the guide sheet 522 rides on top of the fibrous insulation. If there is no fibrous insulation 180, a temporary spacer 524 of appropriate thickness is inserted in the cavity. The multiwall dispense tube 520 is threaded from the top of the cathedral ceiling to the bottom on top of the guide sheet 522. Foam is then injected into the multiwall dispense tube as shown in FIGS. 27 and 28 and as was described above.

Open cavities, containing 4 sides and only 1 wall, requiring insulation are common in new construction and in certain retrofit insulation applications such as basement walls, roof rafters, and rim joists. In these applications, the injection process is used as an alternative to spray foam. Due to the missing cavity wall, foam injected into these cavities will slump out of the cavity without the use of a temporary or permanent molding surface to substitute for the missing cavity wall.

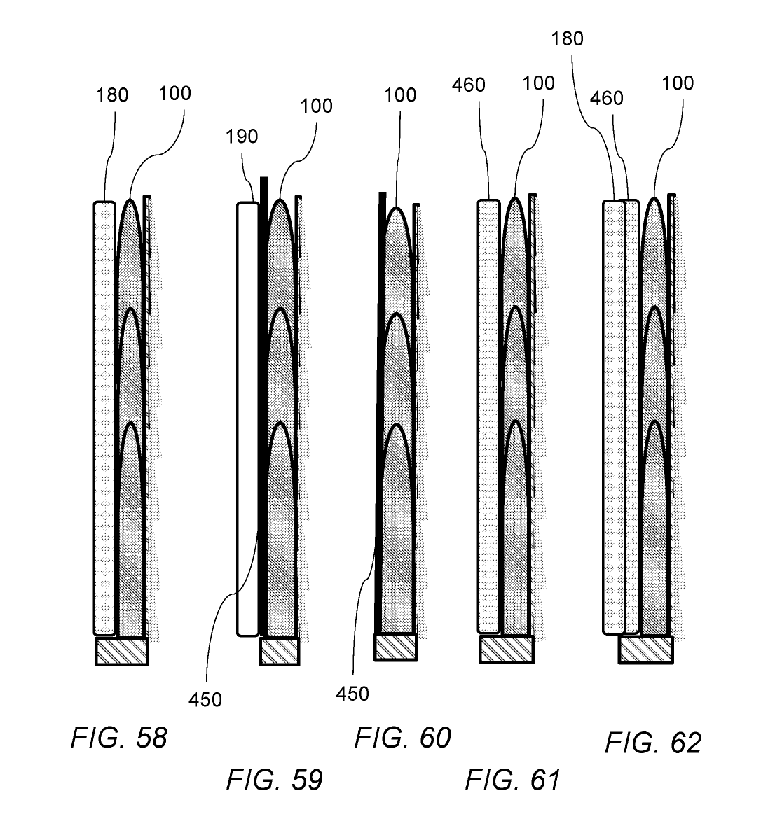

As illustrated in FIGS. 58, 59, 60, 61, and 62, many different materials can serve as temporary or permanent molding surfaces. FIG. 58 illustrates the use of fibrous insulation 180 as the molding surface. In this approach, fibrous insulation 180 is first affixed to cavity sides using standard methods such as stapling or compression fitting. Mixed partially expanded foam is then injected through the fibrous insulation 180 using any of the methods described above. The resultant structure is a hybrid of insulating foam 100 and fibrous insulation 180 that is sometimes referred to as “flash and batt”. Flash and batt provides the air sealing and moisture vapor resistance benefits of insulating foam with the significantly lower cost and fire barrier properties of fibrous insulation. Flash and batt is normally created by first spraying the cavity with spray foam and then applying fibrous insulation. The major advantage of using injection foam rather than spray foam is that the injection foam equipment is inexpensive and thus a single general insulation contractor can complete the entire job without having to call in a separate spray foam contractor. Other benefits include greater worker safety (due to a reduction in aerosol spray particles), eliminated overspray, and better control over foam insulation thickness.

FIG. 59 illustrates the use of a temporary molding surface 190 to serve as the missing cavity wall. Heavy temporary molding surfaces, such as plastic coated plywood or drywall, have been used in the past as temporary molding surfaces for injection foam in open cavities. However, attachment, movement, and storage of these molding surfaces are cumbersome and costly. Due to the low compressive forces generated using the injection methods described above, very lightweight molding surfaces can be used. In one example, inexpensive air filled bladders called “dunnage bags” are affixed to cavity sides to serve as a molding surface. These bags may be coated with a release material such as silicone spray, furniture wax, or petroleum jelly, to enable easy removal from the cured foam. After use, the bags are deflated, rolled up, and easily stored. Similarly inexpensive semi-rigid corrugated polyolefin sheets (with a release film or release coating if needed) can be easily cut to various cavity widths and lengths to serve as a molding surface. To avoid bowing out due to foam expansion pressure, the semi-rigid polyolefin sheets can be cut oversized so that they flex inwards when inserted. They can also be stiffened by filling the corrugations with stiff plastics or with metal rods. Finally, thickness of the mixed fully expanded foam can be controlled by holding the edges of the corrugated sheets with a clamp at a specified depth over the side of the cavity.

As opposed to using a release material, a barrier material 450 is used between the temporary molding surface 190 and the mixed fully expanded foam 100, as shown in FIG. 59 and FIG. 60. In many open cavity applications in which the cavity will not be covered with a fire barrier such as drywall, a fire barrier must be coated on exposed spray foam after application. This is common in roof rafter and basement wall applications. Coating fire barrier materials is a time consuming, expensive and difficult extra step for insulation contractors. However, if a fire barrier film 450 is installed between the temporary molding surface 190 and the partially expanded foam, the fire barrier will adhere to the mixed fully expanded foam 100 after removal of the temporary molding surface 190. Thus the fire barrier and insulating foam can be installed in a single step instead of two steps.

Because open cell foams expand 100 times their liquid volume, contractors are required to trim the foam using special planing devices so that the foam doesn't extend beyond the width of the cavity sides. Trimming of open cell foams is a time consuming extra step and generates much foam waste and dangerous airborne particles. By using a temporary molding surface 190 with open cell foam, foams can be deposited in the exact thickness required and the trimming process can be eliminated.

Additionally, because open cell foams are vapor permeable, some building codes require a vapor barrier to be installed on the interior surface after the foam has been installed. Installation of a vapor barrier can be eliminated by using a vapor barrier film between the temporary molding surface 90 and the partially expanded foam. Of particular interest are “smart” vapor barriers, such as CertainTeed Membrain™, that adjust their vapor permeance based on the moisture content in the cavity.

FIG. 61 and FIG. 62 illustrate that many additional combinations of barrier and insulating materials may be used with the injection foam process. For example, polyisocyanurate foam board costs significantly less, and has significantly better long term insulating value, than a similar volume of two component insulating foam. Polyisocyanurate also uses a blowing agent with extremely low global warming potential compared to two component polyurethane foams. However sealing polyisocyanurate foam board to the inside of a cavity requires time consuming measuring, cutting and sealing of the board. In FIG. 61, mixed fully expanded foam 100 has been injected behind a polyisocyanurate insulation board 460. Similarly FIG. 62 illustrates a hybrid of mixed fully expanded foam 100, insulation board 460, and fibrous insulation 180. The main advantage of this structure is lower cost when filling deep open cavities such as roof rafters.

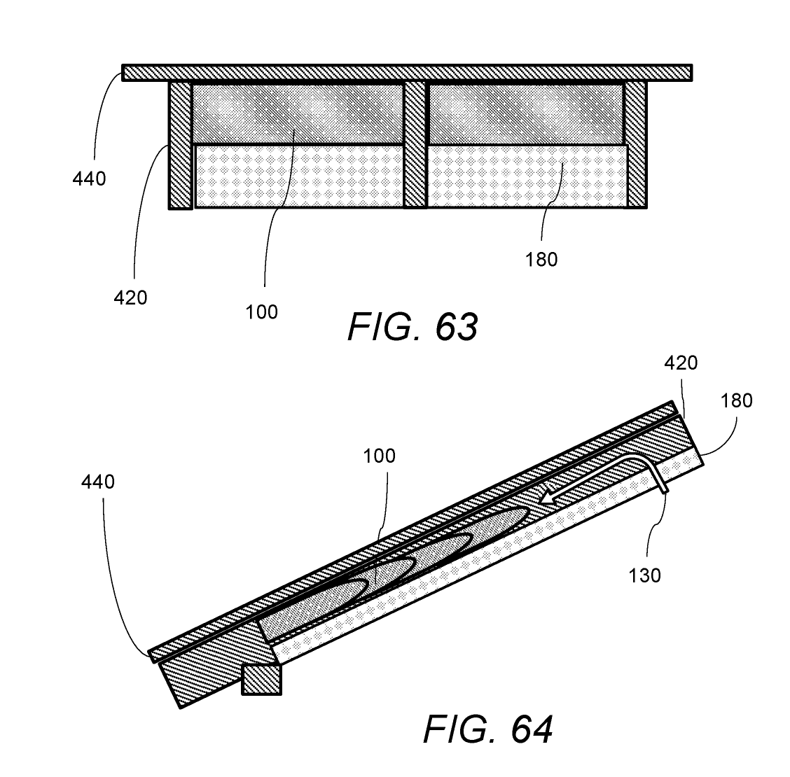

Similar to vertical open cavities, sloped open cavities, as found in roof rafters and illustrated in FIG. 63 and FIG. 64, require the same sort of permanent or temporary molding surfaces as described above and illustrated in FIGS. 58, 59, 60, 61 and 62. Once the molding surface has been attached, the cavity can be injected in the same manner as in the cathedral ceiling injection.

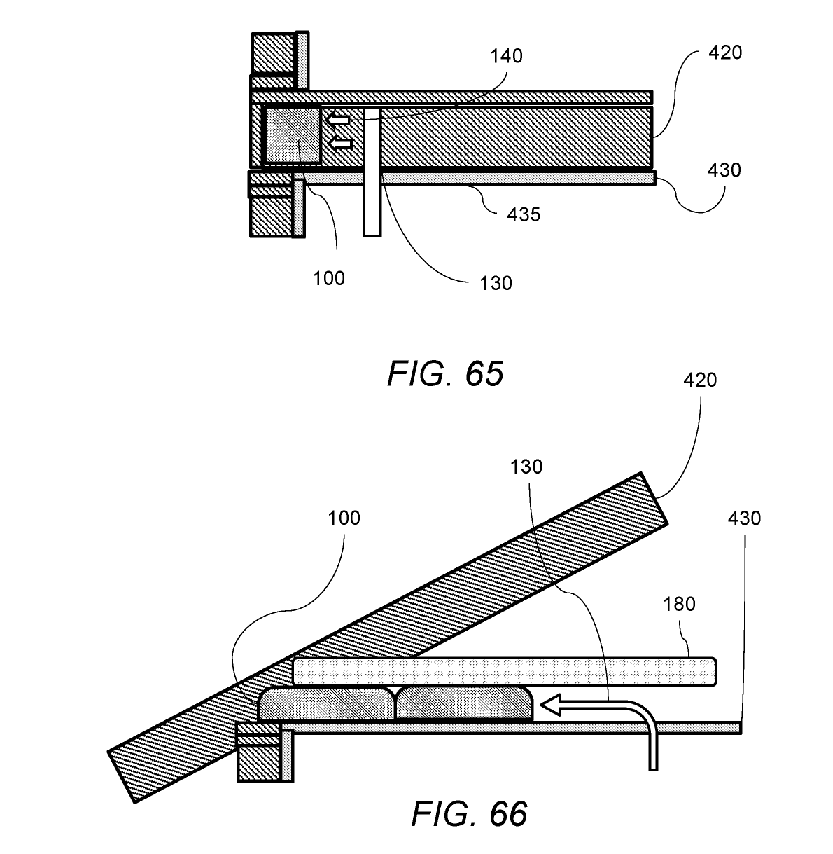

In certain open cavity applications, it is desirable to inject through the closed wall of the cavity rather than through the open side of the cavity. In between floor rim joists, a thickness of mixed fully expanded foam 100 is required that spans the height of floor rafter 420 but that does not extend the length of the floor rafter 420, as shown in FIG. 65. In order to inject these applications, a dispense tube 130 with simultaneous dispense pattern, as described above, is used in conjunction with a quick curing foam. Unlike the slow curing foams used for most injection applications, quick curing foams expand, harden, and cure within 30 seconds or less. After a hole is drilled in the ceiling and a dispense tube 130 is poked through, insulating foam is sprayed from the dispense tube to cover the entire height and width of the wall of the cavity where it adheres and rapidly cures. The use of rapid curing spray foam reduces the tendency of the foam to slump to the bottom of the cavity before it hardens and cures.

Attic floors are another important example of an open cavity injected through a closed wall of the cavity, as shown in FIG. 66. Unlike the cathedral ceiling and roof rafter applications described above, attic floor applications, require injection below fibrous insulation 180. Other than injecting below the fibrous insulation, attic floors are injected in the same manner as cathedral ceilings and roof rafters as described above. Injection of attic floors provides the same air sealing and insulation benefits as injection of roof rafters but, since the distance across the attic floor rafters is much less than the distance from the walls to the peak of the roof rafters, attic floor injection costs substantially less. Injecting from the interior of the structure also avoids the need for insulation contractors to enter enclosed attic spaces and eliminates the need to pull back fibrous insulation in order to insulate and seal attic floors.

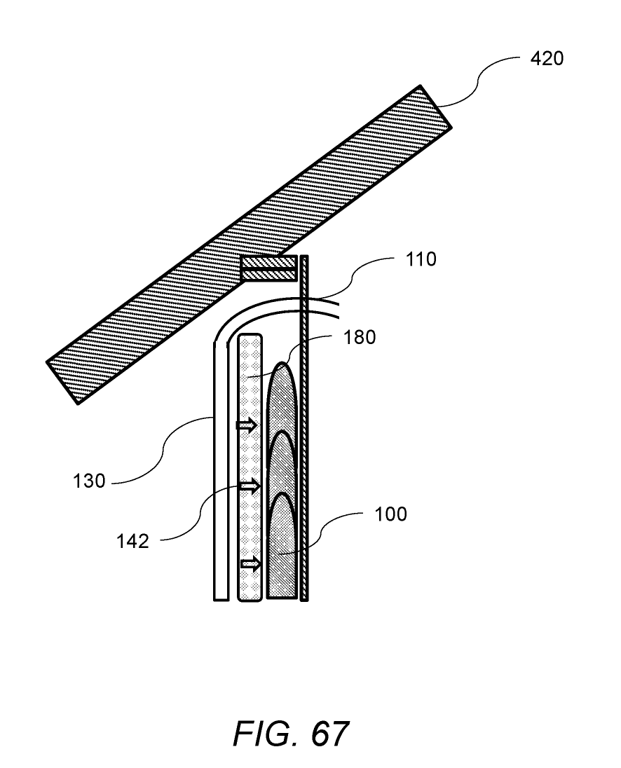

Kneewalls are typically sprayed from the exterior open side of the cavity towards the interior closed side of the cavity. However, spraying kneewalls from the exterior is dangerous because spray foam contractors are required to crawl into very tight confined spaces. At least one death has occurred due to the need to spray kneewalls from the exterior. FIG. 67 illustrates a method of injecting kneewalls from the interior of a structure. A rigid and curved dispense tube 130 is inserted through injection hole 110 on the interior cavity wall. A quick curing partially expanded foam is then sprayed through the dispense tube 130 in a simultaneous spray pattern 142. As described above for between floor rim joists, the quick curing foam hardens and cures before slumping to the bottom of the cavity.

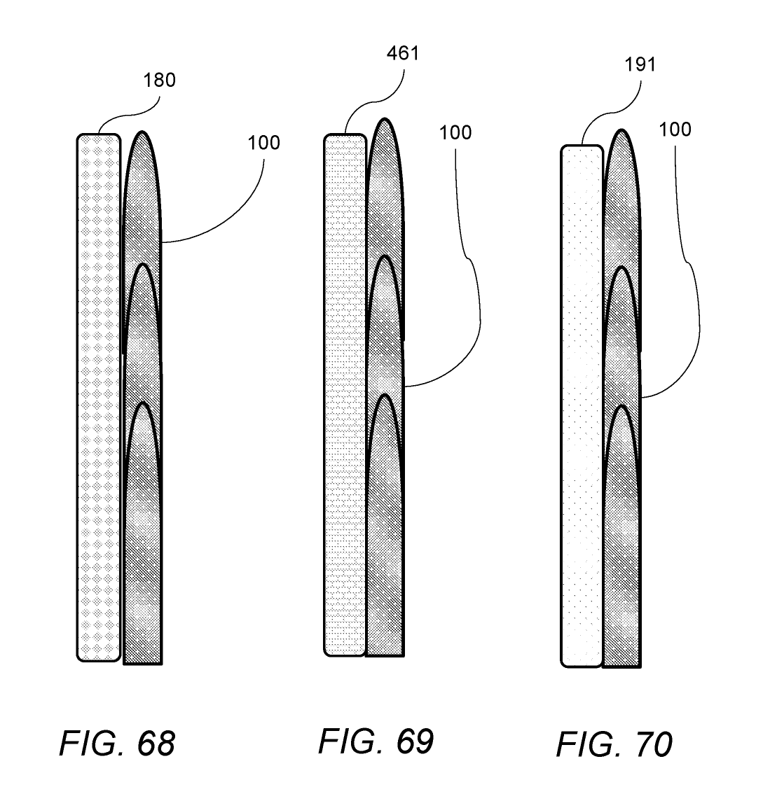

Finally, it should be noted that all of the methods, components and materials described above for injecting into cavities in buildings may also be used to inject into mold cavities for the production of pre-formed insulation products. FIGS. 68, 69 and 70 illustrate three examples of molded products produced using these methods. FIG. 68 is a pre-formed flash and batt product after release from a mold cavity composed of mixed fully expanded foam 100 and fibrous insulation 180. FIG. 69 is a pre-formed foam product including mineral wool 461 and mixed fully expanded foam 100. FIG. 70 is a pre-formed foam product including mixed fully expanded foam 100 and an insulating bladder 191 filled with insulating gas. It will be recognized that many additional structures of pre-formed molded insulation products can be produced using the methods, components, and materials described above.

Several embodiments of the present invention have been described. Nevertheless, it will be understood that various modifications may be made without departing from the spirit and scope of the invention. Accordingly, other embodiments are within the scope of the following claims.

What is claimed is:

1-29. (canceled)

30. A method for filling one or more wall cavities with an expanding insulating foam, the method comprising:
determining a dispense rate for the expanding insulating foam, the determining comprising:
providing a first test cavity comprising at least one elongated wall surface, wherein the elongated wall surface extends along a first direction and comprises first and second opposite sides;
injecting a first portion of the expanding insulating foam into the first test cavity, the injecting being performed for a predetermined first dispense time or to dispense a predetermined first dispense volume of the expanding insulating foam;
allowing the expanding insulating foam to fully expand to provide expanded insulating foam in the first test cavity;
measuring a rise height of the expanded insulating foam in the cavity; then
injecting a second portion of the expanding insulating foam into a second cavity to provide a predetermined rise height of expanded insulating foam in the second cavity, the injecting comprising:
providing the second cavity comprising at least one elongated wall surface, wherein the elongated wall surface extends along a first direction and comprises first and second opposite sides;
based on the dispense rate, determining a shot time or a shot volume suitable to provide the predetermined rise height of expanded insulating foam in the second cavity; and
injecting the expanding insulating foam for the determined shot time or to provide the determined shot volume.

31. The method of claim 30, wherein the rise height is measured by detecting exothermicity associated with the expanded foam as a function of height.

32. The method of claim 31, wherein the exothermicity is detected using an infrared camera.

33. The method of claim 30, wherein the dispense rate is determined based on the measured rise height of the expanded insulating foam, the length of the cavity and the width of the cavity.

34. The method of claim 30, wherein the shot time or a shot volume suitable to provide the predetermined rise height of expanded insulating foam in the second cavity is determined with reference to a shot table.

35. The method of claim 30, wherein the injecting is performed using a shot controller configured to shut off flow of expanding insulating foam when after the determined shot time or after the determined shot volume is dispensed.

36. The method of claim 35, wherein the shot controller determines the shot time or shot volume based on user input.

37. The method of claim 36, wherein the method further comprises inputting into the shot controller the dispense rate, cavity length and cavity width, from which the shot time or shot volume is determined.

38. The method of claim 30, wherein the shot time suitable to provide the predetermined rise height of expanding insulating foam is determined, and wherein the injecting is peformed for the determined shot time.

39. The method of claim 30, wherein the shot volume suitable to provide the predetermined rise height of expanding insulating foam is determined, and wherein the injecting is peformed to provide the determined shot volume.

40. The method of claim 30, wherein the injecting into the second cavity is performed through a hole formed in the elongated wall surface of the second cavity.

41. The method according to claim 40, further comprising patching the hole.

42. The method of claim 40, wherein the second cavity is a closed cavity.

43. The method of claim 30, wherein the expanding insulating foam is a two part A side/B side chemical foam.

44. The method of claim 30, wherein the injecting is performed by dispensing the expanding insulating foam through a dispensing tube.

45. The method of claim 30, wherein each of the first test cavity and the second cavity contains a pre-existing fibrous insulation.

46. The method of claim 30, wherein the first test cavity is in the same field environment as the second cavity.
